(19) United States
(12) Patent Application Publication
(10) Pub. No.: US 2022/0105797 A1
(43) Pub. Date: Apr. 7, 2022

(54) VENTING SYSTEMS AND METHODS

(71) Applicant: Raval A.C.S. Ltd., Beer-Sheva (IL)

(72) Inventors: Omer Vulkan, D.N. Hanegev (IL); Denis Kleyman, Mabu'im (IL)

(21) Appl. No.: 17/426,395

(22) PCT Filed: Mar. 23, 2020
(86) PCT No.: PCT/IL2020/050343

§ 371 Date: Jul. 28, 2021

Related U.S. Application Data
(60) Provisional application No. 62/827,211, filed on Apr. 1, 2019.

(51) Int. Cl. B60K 15/035

(52) U.S. Cl. CPC B60K 15/03504; B60K 2015/03514; B60K 15/03519

(57) ABSTRACT

Venting systems and methods are provided for a fuel system of an engine. In at least one example, the fuel system includes a fuel tank connected to a vapor recovery canister via a main conduit. The venting system includes an electrically actuated vent control valve, a plurality of sensors, and a control unit coupled to the sensors and to the electrically actuated vent control valve. The vent control valve is configured for being installed in the main conduit to thereby enable selectively opening or closing fluid communication between the fuel tank and the vapor recovery canister. The plurality of sensors are configured for providing data indicative of conditions relating to the tank. The control unit is configured for operating the electrically actuated vent control valve to open or close the fluid communication according to first predetermined criteria, wherein the first predetermined criteria include minimizing risk of liquid carry over (LCO) from the fuel tank to the vapor recovery canister. A corresponding method is also provided.

### TECHNOLOGICAL FIELD

The presently disclosed subject matter relates to venting of fuel systems, in particular for use with fuel systems used in vehicles, in particular road vehicles.

### BACKGROUND

Referring to FIG. 1, conventional fuel systems for a vehicle, such as a road vehicle for example, typically include inter alia a fuel tank FT, a vapor recovery canister CC, and one or more valves such as for example Roll-over (RV) valves V1, Holding Pressure Function (HPF) valves V2, fill limit vent valve (FLVV) valves V3, and so on.

For example, the HPF valves V2 are conventionally used in connection with filling/refilling the fuel tank FT. Once the fuel in the fuel tank FT reaches the level the shut-off height (SOH) point of the FLVV valve V3, the FLVV valve V3 is closed and the pressure in the tank FT is raised to the pressure defined by the HPF in the ROV valves V1, the fuel rises in the filler pipe and causes the filling nozzle to close. Conventionally, in the absence of HPF valves V2 the filling nozzle continues to provide fuel past the SOH and the tank FT can become over-filled.

The vapor recovery canister CC, which is in fluid communication with the fuel tank FT via a main conduit MC, accommodates activated carbon which captures hydrocarbon vapors emitted in the fuel system and in particular from the fuel tank. Such emissions occur when the vehicle is travelling, during refiling of the fuel tank, and also while the vehicle is parked.

For example, significant quantities of fuel vapor can escape from a fuel tank and out to the atmosphere during the refueling of motor vehicles, and the fuel tank valves instead vent fuel vapor to a vapor-recovery canister CC during refueling, thereby preventing the vapor from escaping to the atmosphere.

During normal vehicle operation, the fuel level within the tank decreases as fuel is consumed by the vehicle engine (typically an internal combustion engine), and the tank vent valves reopen so that fuel vapor is vented to the vapor recovery canister CC. Excessive sloshing or high pressure within the fuel tank can sometimes cause “liquid carryover” wherein liquid fuel escapes past the valves and travels to the vapor recovery canister along with fuel vapor. Liquid fuel within the vapor recovery canister can contaminate the canister rendering it ineffective.

While parked, fuel vapors accumulate in the tank and are eventually vented to the vapor recovery canister CC.

In normal operation of the engine, the vapor recovery canister CC is periodically purged of the captured fuel vapors by reversing the flow thorough the cabin canister. This is conventionally carried out by opening a valve and providing fluid communication between the engine intake and the vapor recovery canister CC. The purged fuel vapors flow into the engine and are combusted by the engine together with fuel during normal operation of the engine.

### GENERAL DESCRIPTION

According to a first aspect of the presently disclosed subject matter there is provided a venting system for a fuel system, the fuel system including a fuel tank connected to a vapor recovery canister via a main conduit, the venting system comprising:
an electrically actuated vent control valve configured for being installed in the main conduit to thereby enable selectively opening or closing fluid communication between the fuel tank and the vapor recovery canister;
a plurality of sensors for providing data indicative of conditions relating to the tank;
a control unit coupled to the sensors and to the electrically actuated vent control valve, the control unit configured for operating the electrically actuated vent control valve to open or close said fluid communication according to first predetermined criteria, wherein said first predetermined criteria include minimizing risk of liquid carry over (LCO) from the fuel tank to the vapor recovery canister.

For example, the venting system further comprises a direct venting valve for directly venting fuel vapors from the tank to an engine.

Additionally or alternatively, for example, said main conduit comprises a first main conduit portion providing fluid communication between the tank and the vent control valve, and a second main conduit portion providing fluid communication between the vapor recovery canister and the vent control valve. For example, the fuel system comprises a plurality of mechanically actuable valves providing selective fluid communication between said first main conduit portion and the tank, and wherein selective fluid communication between the tank and the second main conduit portion via said plurality of mechanically actuable valves is exclusively via said vent control valve.

Additionally or alternatively, for example, the control unit is configured for determining whether a fuel level in the tank, as sensed by at least one said sensor, exceeds a baseline level of fuel, wherein said baseline level of fuel corresponds to a maximum liquid carry over safe level of fuel in the tank. For example, the control unit is configured for maintaining the vent control valve open if the fuel level is not greater than the baseline level. For example, the control unit is further configured for determining the acceleration/deceleration of the tank. For example, the control unit is further configured for maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

Additionally or alternatively, for example, the control unit is further configured for closing the vent control valve open if:
the control unit determines that the acceleration/deceleration of the tank exceeds a respective baseline acceleration, or, if the control unit determines that the rate of change of said acceleration/deceleration of the exceeds a baseline acceleration rate; and
the control unit determines that a tank pressure is less than a maximum pressure corresponding to an over pressure limit for the tank which should not be exceeded.

Additionally or alternatively, for example, the venting system comprise a conduit directly connecting the fuel tank with the engine, wherein:
the direct venting valve is electrically actuated and configured for being installed in the conduit to thereby enable selectively opening or closing fluid communication between the fuel tank and the engine; and
the control unit is coupled to the sensors and to the direct venting valve, the control unit being configured for operating the direct venting valve to open or close said fluid communication according to second predetermined criteria related to said data.

For example, such a conduit is different from the main conduit.

Additionally or alternatively, for example, said second predetermined criteria include at least pressure conditions in an airspace within the tank being considered desirable for venting to the engine. For example, said pressure conditions comprise a first pressure in the airspace being greater than a second pressure in a portion of said conduit between the direct venting valve and the engine. For example, said first pressure is greater than said second pressure by at least 3 kPa.

Additionally or alternatively, for example, said second predetermined criteria further include temperature conditions in an airspace within the tank being considered desirable for venting to the engine. For example, said temperature conditions include a temperature of greater than 30° C.

Additionally or alternatively, for example, said second predetermined criteria further include fuel vapor quantity conditions in an airspace within the tank being considered desirable for venting to the engine. For example, said fuel vapor quantity conditions is correlated to a predetermined fuel level within the tank. For example, said predetermined fuel level within the tank corresponds to a volume of fuel in the tank that is not greater than 80% of the volume of fuel when the tank is considered to be full.

According to the first aspect of the presently disclosed subject matter there is also provided a fuel system comprising the venting system, vapor recovery canister and fuel tank as defined herein regarding the first aspect of the presently disclosed subject matter.

According to the first aspect of the presently disclosed subject matter there is also provided an assembly of an engine and a fuel system, the fuel system being as defined herein regarding the first aspect of the presently disclosed subject matter, wherein the main conduit is connected to the fuel tank and to the vapor recovery canister.

According to the first aspect of the presently disclosed subject matter there is also provided a vehicle comprising an assembly as defined herein regarding the first aspect of the presently disclosed subject matter.

According to the first aspect of the presently disclosed subject matter there is also provided a method for venting a fuel system, the fuel system comprising at least a fuel tank and a vapor recovery canister, the fuel tank being connected to the vapor recovery canister via a main conduit, and further comprising an electrically actuated vent control valve installed in said main conduit to thereby enable selectively opening or closing fluid communication between the fuel tank and the vapor recovery canister, the method comprising selectively operating the electrically actuated vent control valve to prevent venting of the tank to the vapor recovery canister under predetermined conditions including at least a first said condition indicative of potential liquid carry over from the tank to the vapor recovery canister.

For example, the method optionally further comprises the step of directly venting fuel vapors from the tank to an engine.

Additionally or alternatively, for example, the method comprises determining whether a fuel level in the tank exceeds a baseline level of fuel, wherein said baseline level of fuel corresponds to a maximum liquid carry over safe level of fuel in the tank. For example, the vent control valve is maintained open if the fuel level is not greater than the baseline level.

Additionally or alternatively, for example, the method further comprises determining the acceleration/deceleration of the tank. For example, the method further comprises maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

Additionally or alternatively, for example, the method comprises closing the vent control valve open if:
the acceleration/deceleration of the tank exceeds a respective baseline acceleration, or, if the rate of change of said acceleration/deceleration of the exceeds a baseline acceleration rate; and
a tank pressure is less than a maximum pressure corresponding to an over pressure limit for the tank which should not be exceeded.

Additionally or alternatively, for example, the method comprises selectively operating the electrically actuated vent control valve to allow venting the tank to the vapor recovery canister responsive to a pressure in the tank being greater than a first predetermined threshold.

Additionally or alternatively, for example, the fuel tank is connected to the engine via a conduit, different from said main conduit, and wherein an electrically actuated direct venting valve installed in the conduit to thereby enable selectively opening or closing direct fluid communication between the fuel tank and the engine, the method further comprising
providing data indicative of conditions relating to the tank;
selectively operating the direct venting valve to allow venting the tank directly to the engine according to predetermined criteria related to said data.

For example, said conditions include fuel air ratio conditions in an airspace within the tank, and wherein said predetermined criteria include said pressure conditions considered desirable for venting the tank directly to the engine. For example, said pressure conditions comprise a first pressure in the airspace being greater than a second pressure in a portion of said conduit between the direct venting valve and the engine. For example, said first pressure is greater than said second pressure by at least 3 kPa.

Additionally or alternatively, for example, said predetermined criteria further include temperature conditions in an airspace within the tank being considered desirable for venting to the engine. For example, said temperature conditions include a temperature of greater than 30° C.

Additionally or alternatively, for example, said predetermined criteria further include fuel vapor quantity conditions in an airspace within the tank being considered desirable for venting to the engine. For example, said fuel vapor quantity conditions is correlated to a predetermined fuel level within the tank. For example, said predetermined fuel level within the tank corresponds to a volume of fuel in the tank that is not greater than 80% of the volume of fuel when the tank is considered to be full.

According to a second aspect of the presently disclosed subject matter there is provided a venting system for a fuel system of an engine, the fuel system including a fuel tank connectable directly to the engine via a conduit, the venting system comprising:
an electrically actuated direct venting valve configured for being installed in the conduit to thereby enable selectively opening or closing fluid communication between the fuel tank and the engine;
a plurality of sensors for providing data indicative of conditions relating to the tank;
a control unit coupled to the sensors and to the direct venting valve, the control unit configured for operating the direct venting valve to open or close said fluid communication according to first predetermined criteria related to said data.

For example, said first predetermined criteria include at least pressure conditions in an airspace within the tank being considered desirable for venting to the engine. For example, said pressure conditions comprise a first pressure in the airspace being greater than a second pressure in a portion of said conduit between the direct venting valve and the engine. For example, said first pressure is greater than said second pressure by at least 3 kPa.

Additionally or alternatively, for example, said first predetermined criteria further include temperature conditions in an airspace within the tank being considered desirable for venting to the engine. For example, said temperature conditions include a temperature of greater than 30° C.

Additionally or alternatively, for example, said first predetermined criteria further include fuel vapor quantity conditions in an airspace within the tank being considered desirable for venting to the engine. For example, said fuel vapor quantity conditions is correlated to a predetermined fuel level within the tank. For example, said predetermined fuel level within the tank corresponds to a volume of fuel in the tank that is not greater than 80% of the volume of fuel when the tank is considered to be full.

Additionally or alternatively, for example, the venting system further comprises a main conduit for connecting the tank to a vapor recovery canister, and an electrically actuated vent control valve configured for being installed in the main conduit to thereby enable selectively opening or closing fluid communication between the fuel tank and the vapor recovery canister. For example, the control unit is coupled to the sensors and to the electrically actuated vent control valve, the control unit being further configured for operating the electrically actuated vent control valve to open or close said fluid communication according to second predetermined criteria, wherein said second predetermined criteria include minimizing risk of liquid carry over (LCO) from the fuel tank to the vapor recovery canister.

For example, the control unit is configured for causing the electrically actuated vent control valve to be closed concurrently with the direct venting valve being open.

Additionally or alternatively, for example, the control unit is configured for determining whether a fuel level in the tank, as sensed by at least one said sensor, exceeds a baseline level of fuel, wherein said baseline level of fuel corresponds to a maximum liquid carry over safe level of fuel in the tank. For example, the control unit is configured for maintaining the vent control valve open if the fuel level is not greater than the baseline level. For example, the control unit is further configured for determining the acceleration/deceleration of the tank. For example, the control unit is further configured for maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

Additionally or alternatively, for example, the control unit is further configured for closing the vent control valve open if:
the control unit determines that the acceleration/deceleration of the tank exceeds a respective baseline acceleration, or, if the control unit determines that the rate of change of said acceleration/deceleration of the exceeds a baseline acceleration rate; and
the control unit determines that a tank pressure is less than a maximum pressure corresponding to an over pressure limit for the tank which should not be exceeded

According to the second aspect of the presently disclosed subject matter there is also provided a fuel system comprising the venting system and tank as defined herein according to the second aspect of the presently disclosed subject matter.

According to the second aspect of the presently disclosed subject matter there is also provided an assembly of an engine and a fuel system, the fuel system being as defined herein according to the second aspect of the presently disclosed subject matter, wherein the conduit is connected to the fuel tank and to the engine.

For example, the conduit connects the fuel tank to an intake of the engine.

According to the second aspect of the presently disclosed subject matter there is also provided a vehicle comprising an assembly as defined according to the second aspect of the presently disclosed subject matter.

According to the second aspect of the presently disclosed subject matter there is also provided a method for venting a fuel system of an engine, the fuel system comprising at least a fuel tank and connected to the engine via a conduit, and further comprising an electrically actuated direct venting valve installed in the conduit to thereby enable selectively opening or closing direct fluid communication between the fuel tank and the engine, the method comprising
providing data indicative of conditions relating to the tank;
selectively operating the direct venting valve to allow venting the tank directly to the engine according to first predetermined criteria related to said data.

For example, said conditions include fuel air ratio conditions in an airspace within the tank, and wherein said first predetermined criteria include said pressure conditions considered desirable for venting the tank directly to the engine. For example, said pressure conditions comprise a first pressure in the airspace being greater than a second pressure in a portion of said conduit between the direct venting valve and the engine. For example, said first pressure is greater than said second pressure by at least 3 kPa.

Additionally or alternatively, for example, said first predetermined criteria further include temperature conditions in an airspace within the tank being considered desirable for venting to the engine. For example, said temperature conditions include a temperature of greater than 30° C.

Additionally or alternatively, for example, said first predetermined criteria further include fuel vapor quantity conditions in an airspace within the tank being considered desirable for venting to the engine. For example, said fuel vapor quantity conditions is correlated to a predetermined fuel level within the tank. For example, said predetermined fuel level within the tank corresponds to a volume of fuel in the tank that is not greater than 80% of the volume of fuel when the tank is considered to be full.

Additionally or alternatively, for example, the fuel system comprises at least the fuel tank and a vapor recovery canister, the fuel tank being connected to the vapor recovery canister via a main conduit, and further comprises an electrically actuated vent control valve installed in said main conduit to thereby enable selectively opening or closing fluid communication between the fuel tank and the vapor recovery canister, the method further comprising selectively operating the electrically actuated vent control valve to prevent venting of the tank to the vapor recovery canister under predetermined conditions including at least a first said condition indicative of potential liquid carry over from the tank to the vapor recovery canister.

For example, the method further comprises selectively operating the electrically actuated vent control valve to allow venting the tank to the vapor recovery canister responsive to a pressure in the tank being greater than a first predetermined threshold.

Additionally or alternatively, for example, the method comprises determining whether a fuel level in the tank exceeds a baseline level of fuel, wherein said baseline level of fuel corresponds to a maximum liquid carry over safe level of fuel in the tank.

Additionally or alternatively, for example, the vent control valve is maintained open if the fuel level is not greater than the baseline level.

Additionally or alternatively, for example, the method comprises determining the acceleration/deceleration of the tank. For example, the method comprises maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

Additionally or alternatively, for example, the method comprises closing the vent control valve open if:
the acceleration/deceleration of the tank exceeds a respective baseline acceleration, or, if the rate of change of said acceleration/deceleration of the exceeds a baseline acceleration rate; and
a tank pressure is less than a maximum pressure corresponding to an over pressure limit for the tank which should not be exceeded.

A feature of at least one example of the presently disclosed subject matter is accuracy of control of fuel storage and venting management.

Another feature of at least one example of the presently disclosed subject matter is that accurate and flexible filling control can be achieved.

Another feature of at least one example of the presently disclosed subject matter is that there can be reduced risk of fuel leakage and liquid carry over (LCO) to the vapor recovery canister. For example, compelling the fluid from between the fuel tank and the vapor recovery canister to flow through a single conduit that caries the vapor vent control valve (VCV), and the VCV being configured with a normally closed configuration, reduces the risk of leakage while parked. Furthermore, the risk of LCO under dynamic conditions in which there is likelihood of sloshing can be significantly reduced by operating the VCV via implementation of the “smart” venting methods disclosed herein, for example.

Another feature of at least one example of the presently disclosed subject matter is that the loading of the vapor recovery canister can be reduced significantly as compared with fuel systems not implementing the “smart” venting methods disclosed herein, since the volume of vapor that is transferred to the vapor recovery canister from the fuel tank can be significantly reduced. Furthermore, it is also possible in at least some examples, to thereby reduce the purging/cleaning time required for the vapor recovery canister, and/or the frequency at which the vapor recovery canister is purged/cleaned.

Another feature of at least one example of the presently disclosed subject matter is shorter development time for the fuel system including the vapor recovery canister.

Another feature of at least one example of the presently disclosed subject matter is reduce cost. For example at least some conventional components, for example liquid traps, fill limit vent valves, HPF components can optionally be omitted from the fuel system.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a fuel system of the prior art.

FIG. 2 is a schematic illustration of a venting system according to a first example of the presently disclosed subject matter, installed in a fuel system of a vehicle.

FIG. 3 is a schematic illustration of a method of operating the venting system of the example of FIG. 2 in Operational Mode, according to a first example of the presently disclosed subject matter.

FIG. 4 is schematic illustration of a variation with time of pressure within a fuel tank of the fuel system of the example of FIG. 2.

FIG. 5 is a variation of flow with pressure characteristic for an example of a vent control valve comprised in the example of FIG. 2.

FIG. 6 is a schematic illustration of a method of operating the venting system of the example of FIG. 2 in Refill Mode, according to a first example of the presently disclosed subject matter.

FIG. 7 is a schematic illustration of a venting system according to an alternative variation of the example of FIG. 2 and including a tank venting system according to a first example the presently disclosed subject matter, installed in a fuel system of a vehicle.

FIG. 8 is a schematic illustration of a method of operating the venting system of the example of FIG. 7 in Operational Mode, according to a first example of the presently disclosed subject matter.

### DETAILED DESCRIPTION

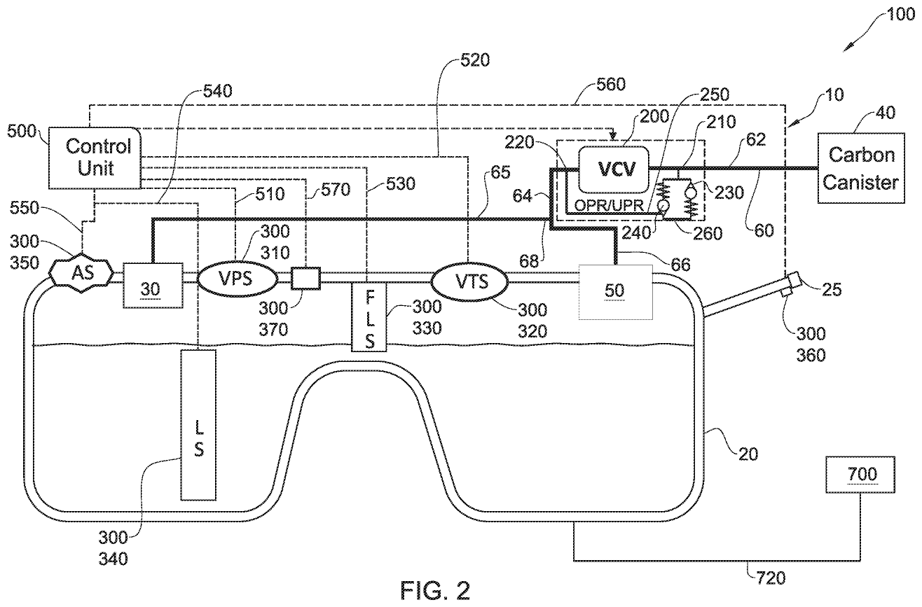

According to an aspect of the presently disclosed subject matter, and referring to FIG. 2, there is provided a venting system, generally designated with reference numeral 100, for a fuel system. As will become clearer herein, the venting system 100 comprises a vent control valve (VCV) 200, one or more sensors 300 and a control unit 500.

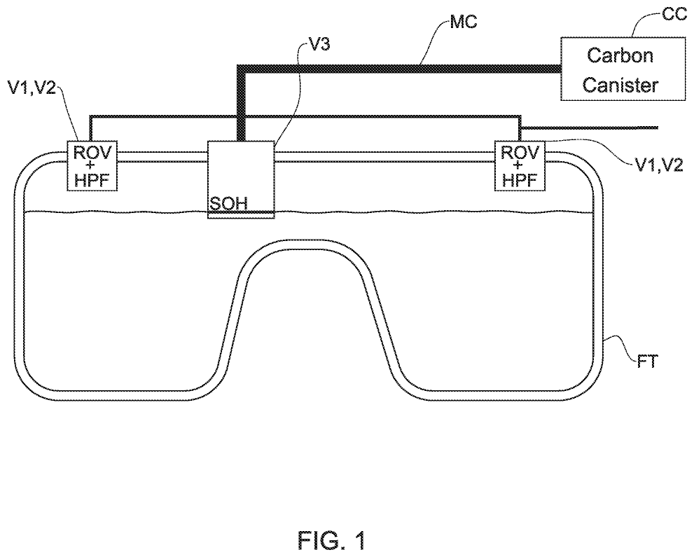

FIG. 2 also schematically illustrates an example of such a fuel system 10 for a vehicle, including inter alia a fuel tank 20, a vapor recovery canister (VRC) 40, and at least one general conduit 60 connecting the fuel tank 20 to the VRC 40. The fuel system 10 typically includes one or more valves, such as for example a roll-over valve (ROV) 30 and a filling roll over valve (FROV) 50. The fuel system 10 can be similar to the conventional fuel system of FIG. 1, for example, and/or can also include other components, for example HPF valves, fill limit vent valve (FLVV) valves, and so on.

In at least the example of FIG. 2, the fuel system also connects the fuel tank to the engine (not shown) via a fuel line (not shown), including other elements such as a fuel pump (not shown). In the normal operation of the fuel system, liquid fuel is pumped to the engine via the fuel line. It is to be noted that in at least this example, the fuel line is different from the at least one general conduit 60 connecting the fuel tank 20 to the VRC 40. For example, the conduit 60 is connected to the fuel tank 20 via the airspace above the level of liquid fuel in the tank, for example via the FROV 50 and/or via the ROV 30. On the other hand, the fuel line is typically connected to a bottom side of the tank, well below the level of liquid fuel in the tank when the tank is at least partially fuel of liquid fuel.

In at least this example, the main conduit 60 connects the fuel tank 20, via the FROV 50, to the VRC 40, and an auxiliary conduit 65 connects the fuel tank 20, via the ROV 30, to the VRC 40, though indirectly via a T-connection 68 with the main conduit 60.

In at least this example, the VCV 200 is installed in the main conduit 60, splitting the main conduit 60 into a first conduit 62 connecting a first port 210 of the VCV 200 to the VRC 40, and a second conduit 64, connecting the tank 20 via the FROV 50 to a second port 220 of the VCV 200. In at least this example the conduit 65 connects the fuel tank 20, via the ROV 30 and the T-connection 68, to the second conduit 64.

In alternative variations of this example there can be additional valves provided in the tank 20 and that are connected to the VRC 40 via additional but separate respective additional conduits that separately connect each valve to the VRC 40. In such examples, these additional conduits are re-routed to the second port 220 of the VCV 200 (for example via additional T-connections to the second conduit 64, or via a suitable manifold arrangement) rather than connected directly to the VRC 40.

According to one aspect of the presently disclosed subject matter, all fluid that flows between the tank 20 and the VRC 40 must pass through the VCV 200, or via the bypass vent arrangement 260 under conditions of exceeding safety thresholds of over-pressure or under-pressure.

In at least this example, the VCV 200 is operable to provide an open position or a closed position. In the open position, fluid communication is allowed between the tank 20 and the VRC 40 via the open VCV 200. In the closed position, fluid communication is prevented between the tank 20 and the VRC 40 via the closed VCV 200.

In at least this example, the VCV 200 is in the form of an electrically actuated valve that is configured for being installed in the main conduit 60, to thereby selectively open or close fluid communication between the fuel tank 20 and the VRC 40.

In at least this example, the VCV 200 is operatively coupled to the control unit 500 via a respective communication line 590.

In at least this example, the VCV 200 is in the normally closed position, in which fluid communication between the tank 20 and the VRC 40 is prevented. In other words, in the absence of any actuating signal or command to open, the VCV 200 is biased to the closed position. Furthermore, in at least this example the VCV 200 is further configured for opening to an open position, responsive to receiving an opening signal or command OC from the control unit 500 via the respective communication line 590, to thereby selectively open to the open position and thus allow fluid communication between the fuel tank 20 and the VRC 40. The VRC 40 is configured such that it remains in the open position only so long as the opening signal or command OC from the control unit 500 is being received by the VCV 40.

In alternative variations of this example, the VCV 200 is in the normally opened position, allowing fluid communication between the tank 20 and the VRC 40; in such examples, the VCV 200 is further configured for closing to the closed position, responsive to receiving a closing signal or command from the control unit 500 via the respective communication line 590, to thereby selectively close to the closed position and thus prevent fluid communication between the fuel tank 20 and the VRC 40.

In at least this example, the VCV 200 also includes a bypass vent arrangement 260 configured for bypassing the VCV 200 and enabling the tank 20 to be vented with respect to the VRC 40 at conditions of a predetermined over-pressure and/or at conditions of a predetermined under-pressure occurring within the tank 20, regardless of whether the VCV 200 is in the open position or in the closed position. For example, the bypass vent arrangement 260 comprises a mechanical over pressure valve (OPV) 240, and a mechanical under pressure valve (UPV) 230, in a bypass conduit 250, for providing fluid communication between the first conduit 62 and the second conduit 64 while bypassing the VCV 200.

The bypass vent arrangement 260 can be integral with, and thus part of, the VCV 200. Alternatively, the bypass vent arrangement 260 can be provided as a separate unit connected to the VCV 200.

Performance of the of the VCV 200, of the OPV 240, and of the UPV 230 can be adjusted according to requirements.

For example, in at least some examples the VCV 200 can be configured having a pressure drop performance of 60 l/min at a pressure of less than 2.5 mbar, and a sealing (air) performance of less than 0.5 cc/min at 120 mbar(Air).

For example, in at least some examples the OPV 240 can be configured having an air leak performances of less than 0.5 cc/min at 50 mbar, and an air flow performance of about 25 L/min at 70 mbar.

For example, in at least some examples the UPV 230 can be configured having an air leak performances of less than 2 CC/min at −10 mbar, and an air flow performance of about 5 L/min at −50 mbar.

For example, in at least some examples, the variation of flow through the VCV 200 when on the open position can vary with pressure, for example as illustrated in FIG. 5.

In at least some variations of this example, the bypass vent arrangement 260 can be omitted.

In any case, for example, such a VCV can include a pressure relief valve, in particular an externally actuated valve, including OPV and UPV mechanical valves, for example as disclosed in WO 2015/114618, assigned to the present assignee. The contents of WO 2015/114618, in particular as included in pages 6 to 12 and FIGS. 1 to 6B, are incorporated herein by reference. In such an example, the respective pressure relief valve can be connected to the fuel tank 20 and the vapor recovery canister 40, and suitably coupled to the control unit 500 which is different from the integral controller of the pressure relief valve disclosed therein.

In another example, such a OPV and UPV can include a pressure relief valve, and the VCV can include as an externally actuated valve, for example as disclosed in WO 2016/071906, assigned to the present assignee. The contents of WO 2016/071906, in particular as included in pages 9 to 20 and FIGS. 1 to 5B, are incorporated herein by reference. In such an example, the respective pressure relief valve can be connected to the fuel tank 20 and the vapor recovery canister 40, and suitably coupled to the control unit 500 which is different from the integral controller of the pressure relief valve disclosed therein.

Each one the one or more sensors 300 is operatively connected to the control unit 500, and is configured for providing respective sensing data to the control unit 500. Such sensing data is generally indicative of a respective parameter PR associated with particular conditions relating to the tank 20. In general, each said parameter PR relates to a particular condition with respect to the tank 20, such that depending in whether the value of this parameter PR is within or outside of a respective threshold TH, it can be desirable for the fluid communication between the tank 20 and the VRC 40 to be open or closed, respectively. In general, having each parameter PR within the respective threshold can be a respective necessary condition, though optionally not sufficient condition, for fluid communication between the tank 20 and the VRC 40 to be open.

As will become clearer herein, the control unit 500 is configured for using respective sensing data received from each sensor 300 to determine whether the VCV 200 should remain in the normally closed position, or whether the VCV 200 should be opened to the open position. Also as will become clearer herein, the control unit 500 is thus configured by using various methods for operating the venting system, which can be embodied in a program in the control unit 500, for example.

In at least this example, the venting system 100 comprises a plurality of different types of sensors 300, including at least one vapor pressure sensor (VPS) 310, at least one vapor temperature sensor (VTS) 320, at least one fill limit level sensor (FLS) 330, at least one level sensor (LS) 340, and at least one acceleration sensor (AS) 350. In alternative variations of this example, the venting system 100 comprises one or more of, but not all of: a VPS 310, a VTS 320, an FLS 330, an LS 340, and an AS 350.

In at least this example, the VPS 310 is configured for monitoring the vapor pressure within the tank 20, in other words, the pressure within the tank 20 as compared with the outside ambient pressure. The respective parameter PR for the VPS 310 is gauge pressure P within the tank 20, and the respective threshold TH can be a pressure range RP between a minimum pressure P_{MIN} and a maximum pressure P_{MAX}.

In at least this example, the VTS 320 is configured for monitoring the vapor temperature within the tank 20, in other words, the temperature within the tank 20. The respective parameter PR for the VTS 320 is the temperature within the tank 20.

In at least this example, the FLS 330 is configured for monitoring whether the fuel fill limit level has been reached within the tank 20. The respective parameter PR for the FLS 330 is the maximum level of fuel allowed within the tank 20 when refilling the tank 20, the tank being horizontal (i.e., from truly horizontal to within between about ±2° to about ±4° from truly horizontal), and not moving. For example a conventional level sensor can be used as the FLS 330, and the controller 500 can be configured to determine when the maximum level of fuel has been reached from the output of the level sensor.

In at least this example, the LS 340 is configured for monitoring the level of fuel within the tank 20. The respective parameter PR for the FLS 330 is the level of fuel within the tank 20, the tank being horizontal (i.e., from truly horizontal to within between about ±2° to about ±4° from truly horizontal), and not moving.

In at least this example, the AS 350 is configured for monitoring the acceleration/deceleration of the tank 20 (generally correlated to the acceleration/deceleration of the vehicle in which the tank 20 is installed). The AS 350 can be configured for monitoring the acceleration/deceleration of the tank 20 along one axis (for example: a first axis X parallel to the longitudinal axis of the vehicle, or alternatively along a second axis Y parallel to a lateral axis (orthogonal to the aforesaid longitudinal axis) of the vehicle, or alternatively along a third axis Z parallel to a vertical axis (orthogonal to the aforesaid lateral axis and to the aforesaid longitudinal axis) of the vehicle). Alternatively, the AS 350 can be configured for monitoring the acceleration/deceleration of the tank 20 along two axes or along three axes (the two or three axes being chosen, for example from: a first axis X parallel to the longitudinal axis of the vehicle; a second axis Y parallel to a lateral axis (orthogonal to the aforesaid longitudinal axis) of the vehicle; a third axis Z parallel to a vertical axis (orthogonal to the aforesaid lateral axis and to the aforesaid longitudinal axis) of the vehicle. The respective parameter PR for the AS 350 is the value of acceleration/deceleration of the tank 20 in each one of the X-axis, Y-axis, and Z-axis, referred to herein as |A_{X}|, |A_{Y}|, |A_{Z}|, respectively. The respective parameter PR for the AS 350 is the level of acceleration/deceleration of the tank 20 along at least one axis, and/or, the level of rate of change of acceleration/deceleration of the tank 20 along at least one axis.

Without being subject to theory, the inventors consider that the parameter of level of acceleration/deceleration of the tank 20 along at least one axis, and/or, the level of rate of change of acceleration/deceleration of the tank 20 along at least one axis, can provide an indication of risk of sloshing in the tank 20. For example, exceeding a threshold value of A₀ for the acceleration along at least one of the X-axis, Y-axis or Z-axis, and/or exceeding a threshold value of dA₀ for the rate of acceleration along at least one of the X-axis. Y-axis or Z-axis, can be correlated to a large (i.e., unacceptable) risk of liquid carryover from the tank 20 to the VRC 40.

The threshold value of A₀ can be the same for the acceleration along each one of the X-axis. Y-axis or Z-axis, or alternatively, the threshold value of A₀ can be different for the acceleration along each one of the X-axis, Y-axis or Z-axis. Additionally or alternatively, the threshold value of dA₀ can be the same for the rate of acceleration along each one of the X-axis, Y-axis or Z-axis, or alternatively, the threshold value of dA₀ can be different for the rate of acceleration along each one of the X-axis, Y-axis or Z-axis.

In at least this example, the plurality of sensors 300 can also include a refueling lid sensor 360 operatively connected to the control unit 500 and is configured for advising the control unit 500 when the refill lid 25 of the tank 20 is opened. The respective parameter PR for the refueling lid sensor 360 is the state of the refill lid 25, whether open (to allow refill of the tank) or closed (where refill of the tank is not permitted).

In at least this example, the VPS 310, the VTS 320, the FLS 330, the LS 340, the AS 350, and the cap sensor 360 are each operatively coupled to the control unit 500 via respective communication lines 510, 520, 530, 540, 550 and 560.

In at least this example, the communication lines 510, 520, 530, 540, 550, 560 and 590 are in the form of one or more buses, or in the form of electrical wiring. In alternative variations of this example, the communication lines 510, 520, 530, 540, 550, 560 and 590 are in the form of wireless communication between the control unit 500 and the respective sensors VPS 310, VTS 320, FLS 330, LS 340, AS 350, cap sensor 360, or VCV 200.

In at least this example, the control unit 500 is configured for operating the VCV 200 (which is in the normally closed position) to open to thereby allow fluid communication between the fuel tank 20 and the VRC 40, and thus allow fuel vapor from the tank 20 to flow to the VRC 40, under a number of different modes, including at least an operating mode OM, a refueling mode RM, and a parked mode PM, according to respective predetermined criteria. In general, and as will become clearer herein, the respective predetermined criteria are generally based on minimizing risk of overpressure occurring in the tank 20, and minimizing risk of liquid carry over from the tank 20 to the VRC 40. In alternative variations of this example in which the VCV 200 is in the normally open position, the control unit 500 is instead configured for operating the VCV 200 to close to thereby thereby prevent fluid communication between the fuel tank 20 and the VRC 40, and thus prevent fuel vapor from the tank 20 to flow to the VRC 40, under corresponding criteria in each one of the respective operating mode OM, refueling mode RM, and parked mode PM.

The control unit 500 can be in the form of a computer or microprocessor at least capable of receiving the sensing date from each of the sensors 300, and capable of processing the sensing data in a predetermined manner to thereby provide an opening signal or commend OC to the VCV 200 to cause the VCV 200 to open to the open position, and thus allow fluid communication between the tank 20 and the VRC 40, according to the aforesaid respective predetermined criteria. For example such processing and predetermined criteria can be provided via a suitable program in the control unit 500.

The control unit 500 can be provided as a stand-alone module, separate from the vehicle computer (e.g., ECU) or the fuel system computer. Alternatively, control unit 500 can be provided as part of the vehicle computer (e.g., ECU) or the fuel system computer, at least in the sense that the functions of the control unit 500, including such processing and predetermined criteria, can be integrated into and provided by, the vehicle computer or the fuel system computer.

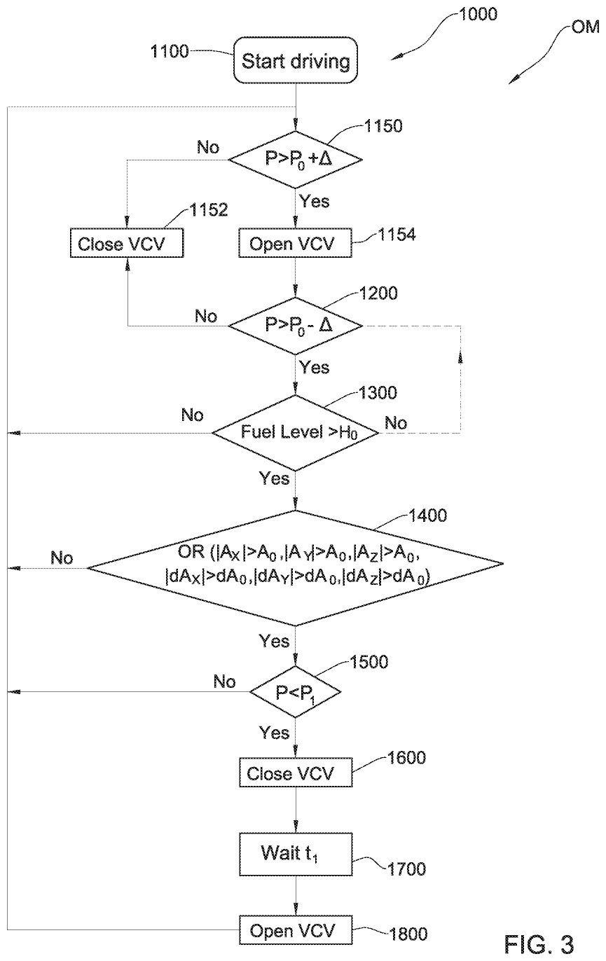

Referring to FIG. 3, a method for operating the venting system 100 in operating mode OM, according to a first example, is generally designated 1000.

The method 1000 can be implemented under conditions in which the vehicle (in which the fuel system 10 and the venting system 100 are installed) is moving under its own power, with the fuel system 10 is operating to provide fuel to the vehicle's engine (typically an internal combustion engine), via the fuel line, and the engine in turn provides the motive power for the vehicle to move. Alternatively, the method 1000 can be implemented under conditions in which the vehicle (in which the fuel system 10 and the venting system 100 are installed) is not moving, for example parked or stopped on a road, but with the engine running (for example in idle), and the fuel system 10 is operating to provide fuel to the vehicle's engine (typically an internal combustion engine).

Accordingly, the venting system 100 is configured for determining, in the first step 1100 of method 1000, whether or not the engine is running, and if the engine is running and therefore capable of providing motive power to the vehicle, then the method can proceed to the next step 1150. For example, the engine computer (ECU) conventionally has one or more indicators that indicate that the engine is running (for example, an rpm counter can provide an indication that the engine is running) that can be used for executing step 1100.

Optionally, the method 1000 can be configured to operate only when the vehicle is moving under the motive power provided by the engine, and in such cases in step 1100 the venting system 100 is configured for determining, whether or not the engine is running, and concurrently that the vehicle is moving. For example the ECU can provide indications that the engine is running (for example via an rpm counter) and that the vehicle is moving (for example via the mileage counter and/or via data provided by one or more accelerometers), for executing step 1100.

In the next step 1150, the venting system 100, in particular the control unit 500, determines whether or not the pressure P (typically gauge pressure) in the tank 20, as sensed by the VPS 310, exceeds a predetermined holding pressure P₀ (in practice, exceeds the holding pressure P₀ plus a hysteresis factor Δ). If the determination at step 1150 is that the tank pressure P is not greater (i.e., is less) than (P₀₊Δ), no action needs to be taken, i.e., the control unit 500 does not send any opening signal or command OC to the VCV 200, and the VCV 200 remains in the normally closed position (1152 in FIG. 3), so that fluid communication between the tank 20 and the VRC 40 continues to be prevented. In such a case, the method returns to step 1150 in which the determination of pressure in the tank is again monitored.

On the other hand, if the determination at step 1150 is that the tank pressure P is greater than (P₀₊Δ), then action needs to be taken, i.e., the control unit 500 sends an opening signal or command OC to the VCV 200, and in step 1154 the VCV 200 opens to the open position, thereby allowing fluid communication between the tank 20 and the VRC 40 so that fuel vapors can now flow into the VRC 40. This in turn serves to reduce the pressure P in the tank 20. The VCV 200 is configured to stay open so long as the control unit 500 continues to send the opening signal or command OC to the VCV 200.

After step 1154 the venting system 100, in particular the control unit 500, continues to monitor the pressure P in the tank 20, as sensed by the VPS 310, in step 1200.

Thus, in the next step 1200, the venting system 100, in particular the control unit 500, determines whether the pressure P in the tank 20, no longer exceeds the holding pressure P₀, or in practice determines that the pressure P is less than holding pressure P₀ less the hysteresis factor Δ, i.e., less than (P₀₋Δ). If the tank pressure P is not greater than (P₀₋Δ), then the control unit 500 determines that the VCV 200 should be closed (1152 in FIG. 3), and the control unit 500 stops sending the opening signal or command OC to the VCV 200 so that the VCV 200 reverts to the normally closed position, thereby preventing fluid communication between the tank 20 and the VRC 40 so that fuel vapors can no longer flow into the VRC 40.

On the other hand, if in step 1200 the pressure P in the tank is greater than (P₀₋Δ), the VCV 200 remains in the open position, with the control unit 500 continuing to send the opening signal or command OC to the VCV 200, and the method 1000 proceeds to step 1300.

In step 1300, the venting system 100, in particular the control unit 500, determines whether the fuel level in the tank 20, as sensed by the LS 340, exceeds a baseline level H₀, which corresponds to a maximum liquid carry over (LCO) safe level of fuel in the tank 20. If the fuel level is not greater than (i.e., is less than) the baseline level H₀, the VCV 200 remains open, and the method returns to step 1150 in which the determination of pressure in the tank is again monitored. Alternatively, if the fuel level is not greater than (i.e., is less than) the baseline level H₀, the method returns to step 1200 (dotted line in FIG. 3).

On the other hand, if in step 1300 the venting system 100, in particular the control unit 500, determines that the fuel level in the tank 20 is greater than the baseline level H₀, the method proceeds to step 1400, while concurrently the VCV 200 remains in the open position, continuing to allow fluid communication between the tank 20 and the VRC 40 so that fuel vapors can no continue to flow into the VRC 40.

In step 1400, the venting system 100, in particular the control unit 500, determines the acceleration/deceleration of the tank (i.e., of the vehicle), as sensed by AS 350, as well as the rate of change of such acceleration/deceleration. The venting system 100, in particular the control unit 500 further determines whether the acceleration/deceleration of the tank 20, along any one of the X-axis, Y-axis or Z-axis, exceeds a respective baseline acceleration A₀, or whether the rate of change of the acceleration/deceleration of the tank 20, along any one of the X-axis. Y-axis or Z-axis, exceeds a respective baseline rate of change of the respective acceleration A₀, i.e., baseline acceleration rate dA₀. The venting system 100, in particular the control unit 500, can determine the rate of change of the acceleration/deceleration of the tank by monitoring the respective acceleration/deceleration of the tank 20 along the respective X-axis, Y-axis or Z-axis, over time.

As disclosed above, the respective threshold value of A₀ can be the same for the acceleration along each one of the X-axis, Y-axis or Z-axis, or alternatively, the respective threshold value of A₀ can be different for the acceleration along each one of the X-axis, Y-axis or Z-axis. Additionally or alternatively, the respective threshold value of dA₀ can be the same for the rate of acceleration along each one of the X-axis, Y-axis or Z-axis, or alternatively, the respective threshold value of dA₀ can be different for the rate of acceleration along each one of the X-axis. Y-axis or Z-axis.

The baseline acceleration A₀ corresponds to acceleration of the tank (and thus of the respective vehicle) under steady state conditions, and can be, for example, in the range from about +2 g to about −2 g (i.e., and acceleration or deceleration up to twice the acceleration due to gravity (nominally g=9.81 m/s²) and typically results in a tilt angle between the level of the fuel in the fuel tank and a nominal horizontal baseline level corresponding to the tank being horizontal and not moving or subject to acceleration forces.

The baseline acceleration rate dA₀ corresponds to acceleration rate of the tank (and thus of the respective vehicle) under non-steady state conditions, for example where the fuel in the tank is experiencing sloshing in the tank. For example, acceleration rate dA₀ can be, for example, in the range from about +0.1 g/sec to about −0.1 g/sec.

If in step 1400 the venting system 100, in particular the control unit 500, determines that the acceleration/deceleration of the tank 20, along each of the X-axis, Y-axis or Z-axis, does not exceed the respective baseline acceleration A₀, and, if the venting system 100, in particular the control unit 500, determines that the rate of change of the respective acceleration/deceleration of the tank 20, along each one of the X-axis. Y-axis or Z-axis, does not exceed the respective baseline acceleration rate dA₀, then, the VCV remains open and the method returns to step 1150 in which the determination of pressure in the tank is again monitored.

On the other hand if in step 1400 the venting system 100, in particular the control unit 500, determines that the acceleration/deceleration of the tank 20, along any one of the X-axis, Y-axis or Z-axis, exceeds the respective baseline acceleration A₀, or, if the rate of change of the acceleration/deceleration of the tank 20, along any one of the X-axis, Y-axis or Z-axis, exceeds the respective baseline acceleration rate dA₀, then, the method proceeds to step 1500, and the VCV remains open.

In alternative variations of this example, if in step 1400 the venting system 100, in particular the control unit 500, determines that the acceleration/deceleration of the tank 20, along each one of any two or more of the X-axis, Y-axis or Z-axis, exceeds the respective baseline acceleration A₀, and/or, if the rate of change of the acceleration/deceleration of the tank 20, along each one of any two or more of the X-axis, Y-axis or Z-axis, exceeds the respective baseline acceleration rate dA₀, then, the method proceeds to step 1500, and the VCV remains open.

In step 1500, the venting system 100, in particular the control unit 500, determines whether the pressure P (typically gauge pressure) in the tank 20, as sensed by the VPS 310, exceeds a maximum pressure P₁ or not.

Pressure P₁ corresponds to the over pressure limit for the tank 20, and which should not be exceeded.

If the venting system 100, in particular the control unit 500, determines at step 1500 that the tank pressure P is not less than P₁, i.e., tank pressure P is greater than P₁, the control unit 500 continues to send the opening signal or command OC to the VCV 200, thereby preventing closing of the VCV 200 and ensuring that fluid communication between the tank 20 and the VRC 40 continues so that fuel vapors can now flow into the VRC 40. This continuing action serves to reduce the pressure P in the tank 20 to at least below P₁. Thereafter, the method returns to step 1150 in which the determination of pressure in the tank is again monitored.

On the other hand, if the determination at step 1500 is that the tank pressure P is less than P₁, the control unit 500 stops sending the opening signal or command OC to the VCV 200, and the VCV 200 reverts to the normally closed position (1600 in FIG. 3), so that fluid communication between the tank 20 and the VRC 40 is now prevented.

After step 1600, the VCV 200 remains in the normally closed position for a period t₁ in step 1700, in which period t₁ corresponds to a predetermined closing pulse width. After period t₁, the control unit 500 sends, in step 1800, an opening signal or command OC to the VCV 200, and the VCV 200 opens to the open position, thereby allowing fluid communication between the tank 20 and the VRC 40 so that fuel vapors can now flow into the VRC 40. Thereafter, the method returns to step 1150 in which the determination of pressure in the tank is again monitored.

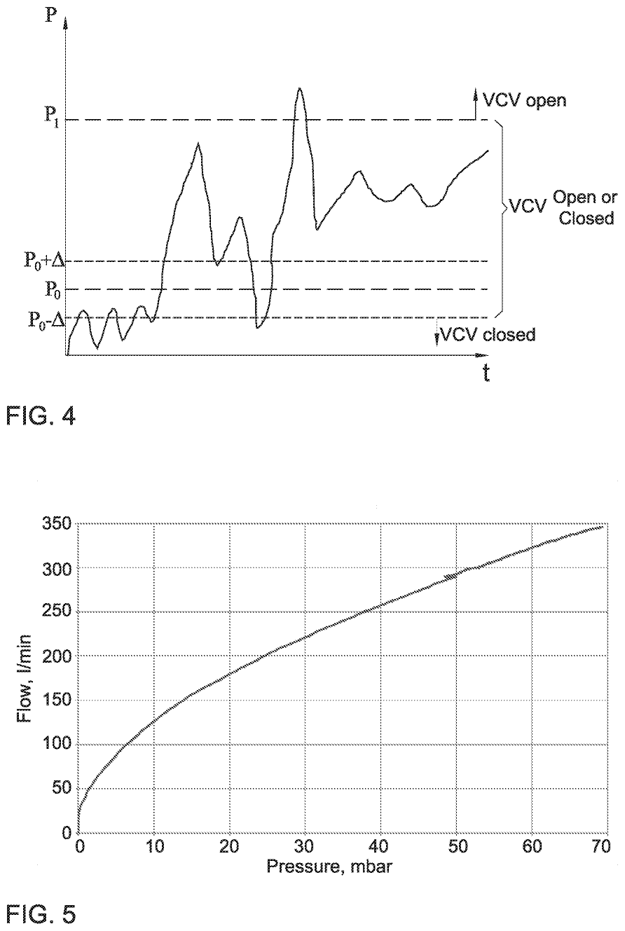

Thus according to at least this example of method 1000, prior to step 1100 the VCV 200 is in the closed position, and the engine is not proving any power. In step 1100 once the engine is running and generating power, the venting procedure of method 1000 can be implemented. Thus, immediately after step 1100 the VCV 200 is in the closed position, while after step 1150 the VCV 200 will be opened or will revert to the closed position according, inter alia, to pressure in the tank and other factors. As can be seen schematically in FIG. 4, the venting system 100, in particular the control unit 500 operates to:
maintain the VCV 200 in the open position whenever the pressure P in the tank 20 is determined to be greater than P₁;
maintain the VCV 200 in the closed position whenever the pressure P in the tank 20 is determined to be less than P₀, or in practice less than (P₀₋Δ);
either open or close the VCV 200 when the whenever the pressure P in the tank 20 is determined to be between P₀ and P₁, or in practice whenever the pressure P in the tank 20 is determined to be between P₀ and (P₀₋Δ) wherein the venting system 100, in particular the control unit 500, determines whether the VCV 200 is to be in the open position or the closed position based on other parameters such as fuel level within the tank and/or acceleration or rate of acceleration of the tank 20, for example.

In at least some variations of the above example of method 1000, the method can be modified to take into consideration temperature data as provided for example by the vapor temperature sensor (VTS) 320. For example, the temperature of the fuel tank can in at least some cases affect the internal geometry of the fuel tank, and thus temperature data as provided for example by the vapor temperature sensor (VTS) 320 can be used in step 1300 to modify the value of Ho to compensate for temperature. For example on a hot day the tank can expand in internal volume, and thus cause the level of fuel to drop for the same volume of fuel.

Additionally or alternatively, the value of the respective baseline acceleration A₀ can change with temperature, and thus temperature data as provided for example by the vapor temperature sensor (VTS) 320 can be used in step 1400 to modify the value of the respective baseline acceleration A₀ and/or to modify the value of the respective baseline rate of acceleration dA₀, to compensate for temperature.

Additionally or alternatively, the value of the pressure P in the tank can change with temperature, and thus temperature data as provided for example by the vapor temperature sensor (VTS) 320 can be used in one or more of steps 1150, 1200, 1500 to modify the value of the respective pressure P₀ and/or P₁, to compensate for temperature.

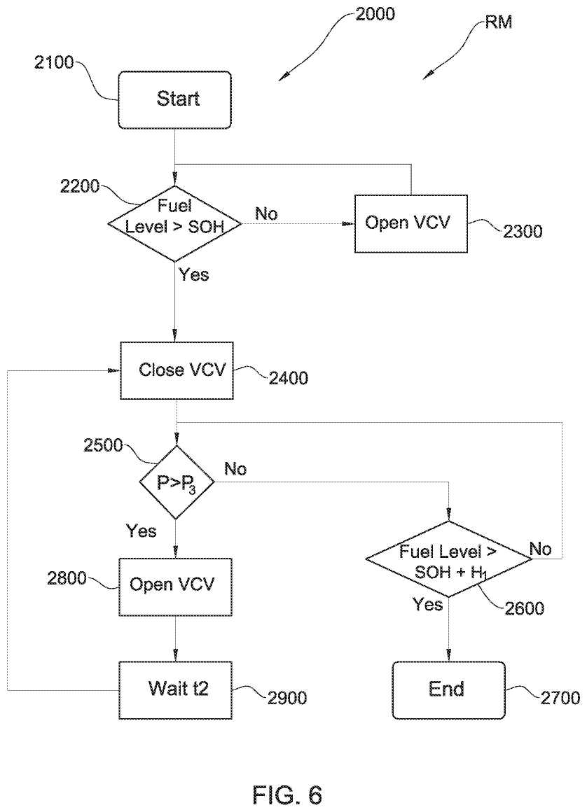

Referring to FIG. 6, a method for operating the venting system 100 in refueling mode RM, according to a first example, is generally designated 2000.

The method 2000 is implemented only under conditions in which the vehicle (in which the fuel system 10 and the venting system 100 are installed) is at rest and the refill cap 25 is open. Accordingly, the venting system 100 is configured for determining, in the first step 2100 of method 1000, whether or not the vehicle is stopped and the refill cap 25 is open, and if so then the method can proceed to the next step 2200. For example, the venting system 100, in particular the control unit 500, determines that the vehicle is stopped by monitoring the sensing data provided by the AS 350, and if the acceleration/deceleration data, at least along the X-axis, is zero, or less than a particular threshold considered to correspond to real-life conditions where the vehicle is stopped, the determination is that the vehicle is stopped. Furthermore, for example, the venting system 100, in particular the control unit 500, determines that the refill cap 25 is open according to the sensing data received from the cap sensor 360.

In step 2200, the venting system 100, in particular the control unit 500, determines whether the fuel level in the tank 20, as sensed by the LS 340, exceeds a shut off height SOH.

The SOH corresponds to a normal capacity safe level of fuel in the tank 20. The SOH is a function of the tilt of the tank 20 (with respect to a nominal position wherein the vehicle is in a stable stopped position on a horizontal surface), tank shape, and temperature inside the tank which indicates expansion of the tank from nominal. Knowledge of tank capacity change with respect to temperature can prevent overfilling of the tank at any condition. Thus the value of the SOH can change in view of the temperature associated with the tank.

If the venting system 100, in particular the control unit 500, determines that the fuel level is not greater than (i.e., less than) the SOH the method proceeds to step 2300 and the control unit 500 sends an opening signal or command OC to the VCV 200, causing the VCV 200 to open to the open position, thereby allowing fluid communication between the tank 20 and the VRC 40. With the VCV 200 in the open position the tank 20 can be vented as gases and vapors in the tank 20 are displaced by the incoming fuel flow into the tank 20.

On the other hand, if in step 2200 the venting system 100, in particular the control unit 500, determines that the fuel level is greater than the SOH the method proceeds to step 2400 and the control unit 500 stops sending the opening signal or command to the VCV 200, and the VCV 200 reverts to the normally closed position, thereby preventing fluid communication between the tank 20 and the VRC 40. Accordingly there is a buildup of pressure in the tank, and this causes a back pressure to be sensed at the pumping station which thereby terminates the refueling process.

In step 2500, which follows step 2400, the venting system 100, in particular the control unit 500, determines whether the pressure P (typically gauge pressure) in the tank 20, as sensed by the VPS 310, exceeds a holding pressure P₃ or not.

Pressure P₃ corresponds to the holding pressure limit for the tank 20 during refueling, and which should not be exceeded, and is related to the holding pressure function for the tank.

If the venting system 100, in particular the control unit 500, determines at step 2500 that the tank pressure P is greater than P₃, then action needs to be taken, i.e., the control unit 500 sends an opening signal or command OC to the VCV 200, and in the following step 2800 the VCV 200 opens to the open position, thereby allowing fluid communication between the tank 20 and the VRC 40 so that fuel vapors can now flow into the VRC 40. This in turn serves to reduce the pressure P in the tank 20 to at least below P₃. After step 2800, the VCV 200 remains in the open position for a period t₂ in step 2900, in which period t₂ corresponds to an opening pulse width. The time period t₂ can be chosen such as to enable the pressure in the tank to reduce to P₃, or as close as possible thereto, for example. In at least some examples, the time period t₂ can be a function of the current pressure in the tank for example the higher the actual pressure in the tank, the longer that time period t₂ can be. After period t₂, the method returns to step 2400, in which the VCV 200 is again closed, and this is followed by step 2500 in which the determination of pressure in the tank is again monitored.

If on the other hand, the venting system 100, in particular the control unit 500, determines at step 2500 that the tank pressure P is not greater than P₃, then the method proceeds to step 2600.

In step 2600, the venting system 100, in particular the control unit 500, determines whether the fuel level in the tank 20, as sensed by the LS 340, exceeds a shut off height SOH plus an additional acceptable over-filing level H₁ above the SOH, i.e., whether the fuel level in the tank 20 is greater than (SOH+H₁).

The additional level H₁ above the SOH corresponds to a maximum safety margin for the level of fuel in the tank 20 that will not lead to overfilling the tank. The additional level H₁ is also a function of the tilt of the tank 20 (with respect to a nominal position wherein the vehicle is in a stable stopped position on a horizontal surface), tank shape, and temperature inside the tank which indicates expansion of the tank from nominal. Knowledge of tank capacity change with respect to temperature can prevent overfilling of the tank at any condition.

If the venting system 100, in particular the control unit 500, determines that the fuel level is not greater than (i.e., less than) the sum (SOH+H₁), the method returns to step 2500 and the pressure inside the tank 20 is again checked against pressure P₃.

On the other hand, if in step 2600 the venting system 100, in particular the control unit 500, determines that the fuel level is greater than the sum (SOH+H₁), the method proceeds to step 2700 and the refueling mode RM terminates.

In a method for operating the venting system 100 in parked mode PM, according to a first example, the VCV 200 is normally closed in the closed position, and the bypass vent arrangement 260 selectively opens or closes fluid communication between the tank 20 and the VRC 40 via the OPV 240 and/or the UPV 230, to maintain the pressure in the tank 20 between the maximum over pressure P₁ and the minimum under-pressure allowed.

In operation the system 100 according to method 1000 can result in reduced the accumulation of vapors in the VRC 40, and thus less need for purging. However, purging of the VRC 40 can be conducted in a conventional manner, in which the VRC 40 is directly purged to the engine via the engine air intake.

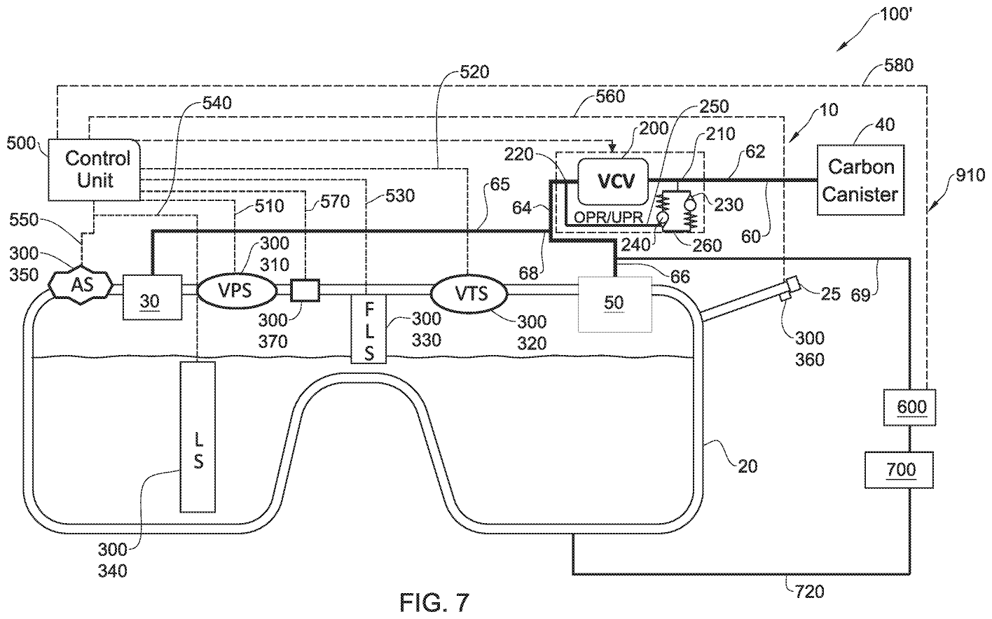

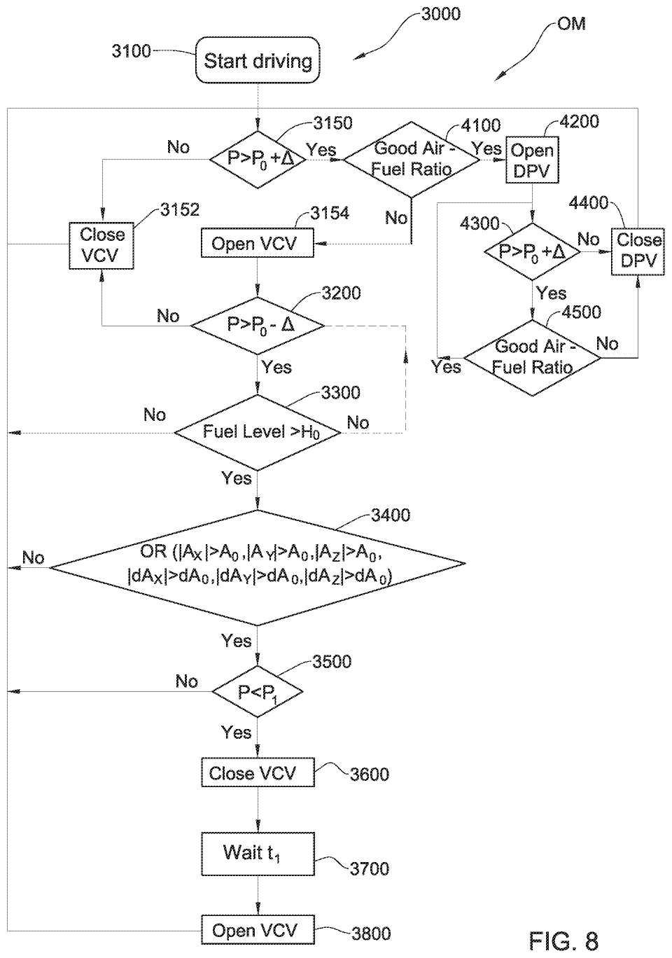

According to another aspect of the presently disclosed subject matter, and referring to FIG. 7, there is provided a venting system, generally designated with reference numeral 100′, for a fuel system. As will become clearer herein, the venting system 100′ comprises a vent control valve (VCV) 200, one or more sensors 300 and a control unit 500 as disclosed above for the venting system 100 of FIG. 2, mutatis mutandis, and the venting system 100′ is further configured to enable selectively venting the tank 20 of fuel vapors directly to the engine 700, rather than allowing the vapors to flow to the VRC 40 via the VCV 200.

Thus, in this example, the venting system 100′ is configured by further comprising a tank venting system 910.

The tank venting system 910 comprises a direct venting valve (DVV) 600, also referred to interchangeably herein as the tank vent valve, connected to the main conduit 60 via tank venting conduit 69. In particular the tank venting conduit 69 is connected to the second conduit 64, for example via a T-connector 66, thereby essentially connecting the tank 20 via the FROV 50 to the DVV 600 while bypassing the VCV 200 and the VRC 40.

In at least this example, the DVV 600 can be similar in structure to the VCV 200, as disclosed above mutatis mutandis, and is thus operable to selectively provide an open position or a closed position. In the open position, fluid communication is allowed between the tank 20 and the engine 700 (in particular the engine intake) via the open DVV 600. In the closed position, fluid communication is prevented between the tank 20 and the engine 700 (in particular the engine intake) via the closed DVV 600.

In at least the example of FIG. 7, the fuel system also connects the fuel tank to the engine 700 via a fuel line 720, including other elements such as a fuel pump (not shown). In the normal operation of the fuel system, liquid fuel is pumped to the engine 700 via the fuel line 720. It is to be noted that in at least this example, the fuel line 720 is different from the tank venting conduit 69 and/or from the at least one general conduit 60 connecting the fuel tank 20 to the VRC 40. For example, the tank venting conduit 69 is connected to the fuel tank 20 via the airspace above the level of liquid fuel in the tank 20, for example via the FROV 50. On the other hand, the fuel line 720 is typically connected to a bottom side of the tank, well below the level of liquid fuel in the tank when the tank is at least partially fuel of liquid fuel.

Thus, in at least this example, the DVV 600 is also in the form of an electrically actuated valve that is configured for being installed in a tank venting conduit 69, to thereby selectively open or close fluid communication between the fuel tank 20 and the engine 700 (in particular the engine intake of engine 700). The tank venting conduit 69 is thus connected between the engine 700 (in particular the engine intake of engine 700) and the tank 20. In at least this example, the tank venting conduit 69 is connected between the engine 700 (in particular the engine intake engine 700) and the second conduit 64 via a T-connector 66.

In at least this example, the DVV 600 is operatively coupled to the control unit 500 via a respective communication line 580.

In at least this example, the DVV 600 is in the normally closed position, in which fluid communication between the tank 20 and the engine 700 (in particular the engine intake of engine 700) is prevented. In other words, in the absence of any actuating signal or command to open, the DVV 600 is biased to the closed position. Furthermore, in at least this example the DVV 600 is further configured for opening to an open position, responsive to receiving an opening signal or command from the control unit 500 via the respective communication line 580, to thereby selectively open to the open position and thus allow fluid communication between the fuel tank 20 and the engine 700 (in particular the engine intake). The DVV 600 remains in the open position only so long as the actuating signal or command to open is being provided by the control unit 500.

In alternative variations of this example, the DVV 600 is in the normally opened position, allowing fluid communication between the tank 20 and the engine 700 (in particular the engine intake of engine 700); in such examples, the DVV 600 is further configured for closing to the closed position, responsive to receiving a closing signal or command from the control unit 500 via the respective communication line 580, to thereby selectively close to the closed position and thus prevent fluid communication between the fuel tank 20 and the engine 700 (in particular the engine intake of engine 700).

In general, the venting system 100′ is configured such that when the DVV 600 is in the open position the VCV 200 is concurrently in the closed position, while when the DVV 600 is in the closed position the VCV 200 can be concurrently in the open position or in the closed position, according to the operation of the controller 500. However, in alternative variations of this example, the venting system 100′ can instead be configured such that when the DVV 600 is in the open position the VCV 200 is concurrently in any one of the closed position, open position or partly open position and thus vapor flow from the tank 20 can be divided between going to the engine 700 and going to the VRC 400.

Thus, in some alternative variations of this example, the DVV 600 and VCV 200 can be replaced with an electrically actuated three-way valve, which selectively alternately allows for:
open fluid communication between the tank and the engine, while concurrently preventing fluid communication between the tank and the VRC 40;
preventing fluid communication between the tank and the engine, while concurrently allowing fluid communication between the tank and the VRC 40;
preventing fluid communication between the tank and the engine, while concurrently preventing fluid communication between the tank and the VRC 40.

In at least this example, the tank venting system 910 is also configured for monitoring conditions in the tank, in particular the airspace above the fuel level in the tank via one or more of the aforesaid sensors 300 and/or other sensors. These sensors can thus provide data indicative of conditions relating to the tank, particular the airspace above the fuel level in the tank. The control unit 500, which is operatively coupled to the sensors and to the DVV 600, is configured for operating the DVV 600 to open or close fluid communication between the fuel tank 20 and the engine 700 according to predetermined criteria related to said data.

For example, such conditions the tank, in particular the airspace above the fuel level in the tank, can relate to the state of the air-fuel ratio within the airspace above the liquid fuel in the tank 20. The respective parameter PR for the air-fuel ratio is air to fuel ratio (volume/volume ratio) within the tank 20 in particular within the airspace above the liquid fuel in the tank 20, and the respective threshold TH can be related to a particular value of this ratio wherein it is economical or otherwise beneficial for the fuel system as well as the engine to vent the fuel vapor to the engine. Such a threshold value can vary according to particulars of the fuel system and/or of the engine, for example. In at least some examples, the respective threshold TH can be a function of the temperature in the tank, and/or the system 100′ can include an air fuel ratio sensor per se, for example a sensor that can analyze or otherwise determine concentration of fuel vapor in the air, or can have a variety of sensors that indirectly provide an indication of the state of the air-fuel ratio within the airspace above the liquid fuel in the tank 20.

In at least this example, the air fuel ratio in the airspace above the fuel in the tank can be considered to be a function of the pressure, temperature and volume of the airspace above the fuel level in the tank.

Alternatively, such conditions in the tank, in particular the airspace above the fuel level in the tank, can relate to at least to the pressure inside the tank, in particular the airspace above the fuel level in the tank. In particular such conditions in the tank, in particular the airspace above the fuel level in the tank, can relate to, in addition to the pressure inside the tank, also to the temperature inside the tank, in particular the airspace above the fuel level in the tank, and or the amount of fuel vapor present in the airspace. For example, the pressure and temperature in the tank, in particular the airspace above the fuel level in the tank, can be determined via the respective VPS 310 and VTS 320, while the amount of fuel vapor present in the airspace can be estimated from the volume of the airspace above the fuel level, which can be determined from a knowledge of the internal geometry of the tank, as well as the height of the fuel level in the tank (for example at nominal horizontal conditions), and which can be provided by the FLS 330.

Furthermore, it can be predetermined that a range of conditions in the tank corresponding to particular combinations of values of temperature, pressure and volume in the tank represent desirable conditions for venting to the engine, while other conditions in the tank corresponding to other combination of values of temperature, pressure and volume in the tank represent conditions that are not desirable for venting to the engine. Such combination of values for temperature, pressure and volume in the tank can be determined, for example empirically.

For example, if the pressure inside the tank, in particular the airspace above the fuel level in the tank, is greater than in the conduit 61 between the DVV 600 and the engine 700, this can suggest desirable conditions for venting the tank to the engine via the DDV 600. For example, such a positive pressure difference can be 3 kPa or greater. In other examples such a positive pressure difference can be greater than said second pressure by any one of: 1 kPa; 2 kPa; 4 kPa; 5 kPa; 6 kPa.

In other examples, such a positive pressure difference can refer to the gauge pressure inside the tank (in particular the airspace above the fuel level in the tank). i.e., the pressure inside the tank (in particular the airspace above the fuel level in the tank) relative to ambient atmospheric pressure.

In some cases a determination of such a positive pressure difference can be sufficient for the controller 500 to open the DVV 600 and allow direct venting from the tank to the engine.

Alternatively, such a positive pressure difference determination can be substantiated with a temperature determination: if in addition to the positive pressure difference, the temperature inside the tank, in particular the airspace above the fuel level in the tank, is greater than a particular threshold temperature, for example greater that 30° C., then the controller 500 operates to open the DVV 600 and allow direct venting from the tank to the engine: but otherwise the controller 500 will not open the DVV 600 if the temperature is below the threshold.

Additionally or alternatively, such a positive pressure difference determination (and optionally also such a threshold temperature determination) can be substantiated with a determination of amount of fuel vapor: if in addition to the positive pressure difference (and optionally in addition to a temperature inside the tank exceed the threshold), the amount of fuel vapor inside the tank, in particular the airspace above the fuel level in the tank, is greater than a particular threshold amount, then the controller 500 operates to open the DVV 600 and allow direct venting from the tank to the engine; but otherwise the controller 500 will not open the DVV 600 if the amount of fuel vapor is below the threshold.

For example, the amount or quantity of fuel vapor conditions can be correlated to a predetermined fuel level within the tank, and said predetermined fuel level within the tank corresponds to a volume of fuel in the tank that is not greater than a fuel level threshold value. For example, the fuel level threshold value can correspond to 80% of the volume of fuel when the tank is considered to be full.

Alternatively, the fuel level threshold value can correspond to a percentage N % of the volume of fuel when the tank is considered to be full, wherein N % can be any one of: 95%, 90%, 85%, 75%, 70%, 65%, 60%, 55%, 50%, 45%, 40%, 35%, 30%, 25%, 20%, 15%, 10%, or 5%.

Alternatively, the fuel level threshold value can correspond to a percentage M % of the volume of fuel when the tank is considered to be full, wherein M % can be any one of: not more than 95%, not more than 90%, not more than 85%, not more than 80%, not more than 75%, not more than 70%, not more than 65%, not more than 60%, not more than 55%, not more than 50%, not more than 45%, not more than 40%, not more than 35%, not more than 30%, not more than 25%, not more than 20%, not more than 15%, not more than 10%, or not more than 5%; less than 5%.

Alternatively, the amount of fuel vapor in the airspace above the fuel in the tank can be estimated for example by determining the level of oxygen in the airspace, and this can be accomplished for example by providing a suitable oxygen sensor 370 on the tank, operatively connected to controller 500 via line 570. For example such an oxygen sensor 570 can include any one of the following, which are well known in the art: a Titanium oxygen sensor, a Zirconia oxygen sensor, a narrow-band oxygen sensor, a wide-band oxygen sensor.

In addition to determining the level of oxygen, the controller 500 can also determine the pressure, temperature, as well as volume of the airspace above the fuel level in the tank. For example, the pressure and temperature in the tank can be determined via the respective VPS 310 and VTS 320, while the volume in the airspace above the fuel level can be determined from a knowledge of the internal geometry of the tank, as well as the height of the fuel level in the tank (for example at nominal horizontal conditions), and which can be provided by the FLS 330.

The controller 500 can then determine, using thermodynamic principles, how much oxygen Mₙₒₘᵢₙₐₗ would be required to fully occupy this volume at the corresponding temperature and pressure, and compares this nominal amount of oxygen Mₙₒₘᵢₙₐₗ with the actual amount of oxygen M_{actual} measured by the oxygen sensor. The closer the two amounts M_{actual} and Mₙₒₘᵢₙₐₗ are to one another, the less the quantity of fuel vapor is considered to be in the airspace in the tank. On the other hand the lower M_{actual} is relative to Mₙₒₘᵢₙₐₗ, the larger the quantity of fuel vapor is in the airspace in the tank.

In at least this example, the communication line 580 is also in the form of one or more buses, or in the form of electrical wiring. In alternative variations of this example, the communication line 580 is in the form of wireless communication between the control unit 500 and the DVV 600. Optionally, in non-wireless examples, CAN-BUS matrix or similar protocols can be used.

According to aspects of the presently disclosed subject matter, and referring to FIG. 8, a method for operating the venting system 100′ in operating mode OM, according to another example, is generally designated 3000, and integrates the venting function of the DVV 600 and the venting function of the VCV 200.

The method 3000 is implemented only under conditions in which the vehicle's engine is operating, either in idle or providing motive power for the vehicle to move. Accordingly, the venting system 100′ is configured for determining, in the first step 3100 of method 3000, whether or not the engine is operating, and if the engine is operating, then the method can proceed to the next step 3150. For example, if control unit 500 is energized, this is generally indicative that engine is running. Furthermore, if the control unit 500 is connected to the engine control unit (ECU), the control unit 500 can receive the signals from ECU. On the other hand, if the control unit 500 is not connected to the ECU, the control unit 500 can detect that the engine is running, for example via accelerations/vibrations detected by the accelerometers.

Step 3150 is similar to step 1150 of method 1000, mutatis mutandis.

In step 3150, the venting system 100′, in particular the control unit 500, determines whether or not the pressure P (typically gauge pressure) in the tank 20, as sensed by the VPS 310, exceeds a predetermined holding pressure P₀ (in practice, exceeds the holding pressure P₀ plus a hysteresis factor Δ). If the determination at step 3150 is that the tank pressure P is not greater (i.e., is less) than (P₀₊Δ), no action needs to be taken, i.e., the control unit 500 does not send any opening signal or command OC to the VCV 200, and the VCV 200 remains in the normally closed position (3152 in FIG. 8), so that fluid communication between the tank 20 and the VRC 40 continues to be prevented. In such a case, the method returns to step 3150 in which the determination of pressure in the tank is again monitored.

On the other hand, if the determination at step 3150 is that the tank pressure P is greater than (P₀₊Δ), then action needs to be taken, and the method proceeds to step 4100. This action is either venting of the tank via the VCV 200, or purging of the tank 20 via the DVV 600, as will become clearer herein.

In step 4100, the venting system 100′, in particular the control unit 500, determines whether or not the “air-fuel ratio” in the tank, i.e., on the open space above the level of liquid fuel in the tank 20, as determined by the venting system 100′, is “good”, in other words, that the conditions in the tank, in particular the air space above the fuel level in the tank, are desirable for venting the tank directly to the engine via the DVV 600.

For, such conditions can correspond to a range of particular combinations of pressure, temperature and tank airspace volume conditions that are indicative of desirable conditions in the tank airspace for venting the airspace directly to the engine.

Clearly, the conditions can change according to the manner of operation of the engine, the type and power output of the engine, as well as with environmental conditions, and conditions in the tank, for example pressure, temperature and/or and level of fuel in the tank. For example the tank conditions when the engine is idling can be very different from the tank conditions when the engine is providing acceleration to the vehicle, or when the vehicle is travelling with a heavy load, or when the vehicle is traveling on the highway at a steady speed.

Optionally, data relating to the desirable tank conditions can be related to the fuel injection system of the vehicle and can be used to enable the amount of fuel injected to the engine to be adjusted to take into account the quantity of fuel vapors being vented to the engine, and thus maintain the air-fuel ratio being provided to the engine via the fuel injection system (or carburetor) and tank venting at (typically) the stoichiometric ratio for the particular type of fuel, plus or minus an acceptable margin.

If the venting system 100′, in particular the control unit 500, determines in step 4100 that the tank conditions are exceeding the desired respective thresholds (corresponding to a desirable or “good” air-fuel ratio), the method 3000 continues to step 4200 to allow venting of the tank 20 via the DVV 600. In step 4200 the control unit 500 sends an opening signal or command to the DVV 600, and the DVV 600 opens to the open position, thereby allowing fluid communication between the tank 20 and the engine 700 (in particular the air intake thereof) so that fuel vapors can now flow directly into the engine 700 and get consumed therein by combustion. This in turn can serves to reduce the loading on the VRC 40.

After step 4200, the venting system 100′, in particular the control unit 500, continues to monitor the pressure P in the tank 20, as sensed by the VPS 310, in step 4300.

In step 4300, the venting system 100′, in particular the control unit 500, determines whether or not the pressure P (typically gauge pressure) in the tank 20, as sensed by the VPS 310, exceeds the predetermined holding pressure P₀ (in practice, exceeds the holding pressure P₀ plus a hysteresis factor Δ). If the determination at step 4300 is that the tank pressure P is not greater (i.e., is less) than (P₀₊Δ), no action needs to be taken, i.e., the control unit 500 does not send any opening signal or command to the DVV 600, and the DVV 600 reverts to the normally closed position (4400 in FIG. 8), so that fluid communication between the tank 20 and the engine 700 is prevented. In such a case, the method returns to step 3150 in which the determination of pressure in the tank is again monitored.

On the other hand, if the determination at step 4300 is that the tank pressure P is greater than (P₀₊Δ), then action needs to be taken, and the method proceeds to step 4500. Step 4500 is similar to step 4100, mutatis mutandis, and again the conditions in the tank 20 is again monitored via the venting system 100′.

Thus, in step 4500, the venting system 100′, in particular the control unit 500, determines whether or not the conditions in the tank, i.e., on the open space above the level of liquid fuel in the tank 20, as determined by the venting system 100′, are considered desirable for venting or not.

If the venting system 100′, in particular the control unit 500, determines in step 4500 that the conditions in the tank are desirable for venting (corresponding to a desirable or “good air-fuel ratio”), the DVV 600 continues to stay open to allow venting of the tank 20 via the DVV 600 to continue, and the method 3000 returns to step 4300.

On the other hand, if the venting system 100′, in particular the control unit 500, determines in step 4500 that the a conditions in the tank are not desirable for venting (no longer corresponding to a desirable or “good air-fuel ratio”), the control unit 500 stops sending the opening signal or command to the DVV 600, and the DVV 600 reverts to the normally closed position (4400 in FIG. 8). In such a situation, fluid communication between the tank 20 and the engine 700 is prevented, and the method 3000 returns to step 3150 in which the determination of pressure in the tank is again monitored.

If in step 4100, on the other hand, the venting system 100′, in particular the control unit 500, determines that the conditions in the tank are not desirable for venting (i.e., no longer corresponding to a “good” air-fuel ratio), the method 3000 continues to step 3154 instead of step 4200 to selectively provide venting of the tank 20 via the VCV 200, and the DVV 600 remains in the closed position.

In step 3154 the VCV 200 opens to the open position, thereby allowing fluid communication between the tank 20 and the VRC 40 so that fuel vapors can now flow into the VRC 40. This in turn serves to reduce the pressure P in the tank 20.

After step 3154 the venting system 100, in particular the control unit 500, continues to monitor the pressure P in the tank 20, as sensed by the VPS 310, in step 3200, which is similar to step 1200 of method 1000, mutatis mutandis.

Thus, in the next step 3200, the venting system 100′, in particular the control unit 500, determines whether the pressure P in the tank 20, exceeds the holding pressure P₀, or in practice determines that the pressure P is greater than holding pressure P₀ less the hysteresis factor Δ, i.e., less than (P₀₋Δ). If the holding pressure P₀ is not greater than (P₀₋Δ), then the control unit 500 stops sending the opening signal or command to the VCV 200 (3152 in FIG. 8), and the VCV 200 reverts to the normally closed position, thereby preventing fluid communication between the tank 20 and the VRC 40 so that fuel vapors can no longer flow into the VRC 40.

On the other hand, if in step 3200 the pressure P in the tank is greater than (P₀₋Δ), the VCV 200 remains in the open position, and the method 3000 proceeds to step 3300, which is similar to step 3300 of method 1000, mutatis mutandis.

In step 3300, the venting system 100′, in particular the control unit 500, determines whether the fuel level in the tank 20, as sensed by the LS 340, exceeds a baseline level H₀, which corresponds to a maximum LCO safe level of fuel in the tank 20. If the fuel level is not greater than (i.e., less than) the baseline level H₀, the VCV 200 remains open, and the method returns to step 3150 in which the determination of pressure in the tank is again monitored Alternatively, if the fuel level is not greater than (i.e., is less than) the baseline level H₀, the method returns to step 3200 (dotted line in FIG. 8).

On the other hand, if in step 3300 the venting system 100′, in particular the control unit 500, determines that the fuel level in the tank 20 is greater than the baseline level H₀, the method proceeds to step 3400, while concurrently the VCV 200 remains in the open position, continuing to allow fluid communication between the tank 20 and the VRC 40 so that fuel vapors can no continue to flow into the VRC 40.

In step 3400, the venting system 100′, in particular the control unit 500, determines the acceleration/deceleration of the tank (i.e., of the vehicle), as sensed by AS 350, as well as the rate of change of such acceleration/deceleration. The venting system 100′, in particular the control unit 500 further determines whether the acceleration/deceleration of the tank 20, along any one of the X-axis. Y-axis or Z-axis, exceeds a respective baseline acceleration A₀, or whether the rate of change of the acceleration/deceleration of the tank 20, along any one of the X-axis, Y-axis or Z-axis, exceeds a respective baseline rate of change of acceleration A₀, i.e., baseline acceleration rate dA₀. The venting system 100′, in particular the control unit 500, can determine the rate of change of the acceleration/deceleration of the tank by monitoring the respective acceleration/deceleration of the tank 20 along the respective X-axis, Y-axis or Z-axis, over time.

As disclosed above, the respective threshold value of A₀ can be the same for the acceleration along each one of the X-axis, Y-axis or Z-axis, or alternatively, the respective threshold value of A₀ can be different for the acceleration along each one of the X-axis, Y-axis or Z-axis. Additionally or alternatively, the respective threshold value of dA₀ can be the same for the rate of acceleration along each one of the X-axis, Y-axis or Z-axis, or alternatively, the respective threshold value of dA₀ can be different for the rate of acceleration along each one of the X-axis, Y-axis or Z-axis.

The baseline acceleration A₀ corresponds to acceleration of the tank (and thus of the respective vehicle) under steady state conditions, and can be, for example, in the range from about +2 g to about −2 g (i.e., and acceleration or deceleration up to twice the acceleration due to gravity (nominally g=9.81 m/s²) and typically results in a tilt angle between the level of the fuel in the fuel tank and a nominal horizontal baseline level corresponding to the tank being horizontal and not moving or subject to acceleration forces.

The baseline acceleration rate dA₀ corresponds to acceleration rate of the tank (and thus of the respective vehicle) under non-steady state conditions, for example where the fuel in the tank is experiencing sloshing in the tank. For example, acceleration rate dA₀ can be, for example, in the range from about +0.1 g/sec to about −0.1 g/sec.

If in step 3400 the venting system 100′, in particular the control unit 500, determines that the acceleration/deceleration of the tank 20, along each one of the X-axis, Y-axis or Z-axis, does not exceed the respective baseline acceleration A₀, and, if the venting system 100′, in particular the control unit 500, determines that the rate of change of the acceleration/deceleration of the tank 20, along each one of the X-axis. Y-axis or Z-axis, does not exceed the respective baseline acceleration rate dA₀, then, the method returns to step 3150 in which the determination of pressure in the tank is again monitored. The control unit 500 continues sending the opening signal or command to the VCV 200, which thus remains in the open position.

On the other hand if in step 3400 the venting system 100′, in particular the control unit 500, determines that the acceleration/deceleration of the tank 20, along any one of the X-axis. Y-axis or Z-axis, exceeds the respective baseline acceleration A₀, or, if the rate of change of the acceleration/deceleration of the tank 20, along any one of the X-axis. Y-axis or Z-axis, exceeds the respective baseline acceleration rate dA₀, then, the method proceeds to step 3500, which is similar to step 1500 of method 1000, mutatis mutandis. The control unit 500 continues sending the opening signal or command to the VCV 200, which thus remains in the open position.

In alternative variations of this example, if in step 3400 the venting system 100′, in particular the control unit 500, determines that the acceleration/deceleration of the tank 20, along each one of any two or more of the X-axis, Y-axis or Z-axis, exceeds the respective baseline acceleration A₀, and/or, if the rate of change of the acceleration/deceleration of the tank 20, along each one of any two or more of the X-axis. Y-axis or Z-axis, exceeds the respective baseline acceleration rate dA₀, then, the method proceeds to step 3500, and the VCV 200 remains open.

In step 3500, the venting system 100′, in particular the control unit 500, determines whether the pressure P (typically gauge pressure) in the tank 20, as sensed by the VPS 310, exceeds the aforesaid maximum pressure P₁ or not.

If the venting system 100′, in particular the control unit 500, determines at step 3500 that the tank pressure P is not less than P₁, i.e., tank pressure P is greater than P₁. This in turn serves to reduce the pressure P in the tank 20 to at least below P₁. Thereafter, the method returns to step 3150 in which the determination of pressure in the tank is again monitored.

On the other hand, if the determination at step 3500 is that the tank pressure P is less than P₁, no action needs to be taken. i.e., the control unit 500 does not send any opening signal or command OC to the VCV 200, and the VCV 200 remains in the normally closed position (3600 in FIG. 8), so that fluid communication between the tank 20 and the VRC 40 is prevented.

After step 3600, the VCV 200 remains in the normally closed position for a period t₁ in step 3700, in which period t₁ corresponds to a closing pulse width.

After period t₁, the control unit 500 sends, in step 3800, an opening signal or command OC to the VCV 200, and the VCV 200 opens to the open position, thereby allowing fluid communication between the tank 20 and the VRC 40 so that fuel vapors can now flow into the VRC 40. Thereafter, the method returns to step 3150 in which the determination of pressure in the tank is again monitored.

Thus, the venting system 100′, in particular the control unit 500 operates to:
vent the tank 20 directly to the engine when the air fuel ratio in the tank 20 is acceptable/desirable (“good”);
when the air fuel ratio in the tank 20 is not acceptable/desirable, venting the tank to the VRC 40 by maintaining the VCV 200 in the open position whenever the pressure P in the tank 20 is determined to be greater than P₁;
maintain the VCV 200 in the closed position whenever the pressure P in the tank 20 is determined to be less than P₀ or in practice less than (P₀₋Δ);
either open or close the VCV 200 when the whenever the pressure P in the tank 20 is determined to be between P₀ and P₁, or in practice between P₀ and (P₀₋Δ), wherein the venting system 100, in particular the control unit 500, determines whether the VCV 200 is to be in the open position or the closed position based on other parameters such as fuel level within the tank and/or acceleration or rate of acceleration of the tank 20, for example.

In at least some variations of the above example of method 3000, the method can be modified to take into consideration temperature data as provided for example by the vapor temperature sensor (VTS) 320. For example, the temperature of the fuel tank can in at least some cases affect the internal geometry of the fuel tank, and thus temperature data as provided for example by the vapor temperature sensor (VTS) 320 can be used in step 3300 to modify the value of Ho to compensate for temperature. For example on a hot day the tank can expand in internal volume, and thus cause the level of fuel to drop for the same volume of fuel.

Additionally or alternatively, the value of the respective baseline acceleration A₀ can change with temperature, and thus temperature data as provided for example by the vapor temperature sensor (VTS) 320 can be used in step 4400 to modify the value of the respective baseline acceleration A₀ and/or to modify the value of the respective baseline rate of acceleration dA₀, to compensate for temperature.

Additionally or alternatively, the value of the pressure P in the tank can change with temperature, and thus temperature data as provided for example by the vapor temperature sensor (VTS) 320 can be used in one or more of steps 3150, 3200, 3500 to modify the value of the respective pressure P₀ sand/or P₁, to compensate for temperature.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A venting system for a fuel system, the fuel system including a fuel tank connected to a vapor recovery canister via a main conduit, the venting system comprising:
an electrically actuated vent control valve configured for being installed in the main conduit to thereby enable selectively opening or closing fluid communication between the fuel tank and the vapor recovery canister;
a plurality of sensors for providing data indicative of conditions relating to the tank;
a control unit coupled to the sensors and to the electrically actuated vent control valve, the control unit configured for operating the electrically actuated vent control valve to open or close said fluid communication according to first predetermined criteria, wherein said first predetermined criteria include minimizing risk of liquid carry over (LCO) from the fuel tank to the vapor recovery canister.

2. The venting system according to claim 1, further comprising a direct venting valve for directly venting fuel vapors from the tank to an engine.

3. The venting system according to any one of claims 1 to 2, said main conduit comprises a first main conduit portion providing fluid communication between the tank and the vent control valve, and a second main conduit portion providing fluid communication between the vapor recovery canister and the vent control valve.

4. The venting system according to claim 3, wherein the fuel system comprises a plurality of mechanically actuable valves providing selective fluid communication between said first main conduit portion and the tank, and wherein selective fluid communication between the tank and the second main conduit portion via said plurality of mechanically actuable valves is exclusively via said vent control valve.

5. The venting system according to any one of claims 1 to 4, wherein the control unit is configured for determining whether a fuel level in the tank, as sensed by at least one said sensor, exceeds a baseline level of fuel, wherein said baseline level of fuel corresponds to a maximum liquid carry over safe level of fuel in the tank.

6. The venting system according to claim 5, wherein the control unit is configured for maintaining the vent control valve open if the fuel level is not greater than the baseline level.

7. The venting system according to claim 6, wherein the control unit is further configured for determining the acceleration/deceleration of the tank.

8. The venting system according to claim 7, wherein the control unit is further configured for maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

9. The venting system according to claim 7 or claim 8, wherein the control unit is further configured for closing the vent control valve open if:
the control unit determines that the acceleration/deceleration of the tank exceeds a respective baseline acceleration, or, if the control unit determines that the rate of change of said acceleration/deceleration of the exceeds a baseline acceleration rate; and
the control unit determines that a tank pressure is less than a maximum pressure corresponding to an over pressure limit for the tank which should not be exceeded.

10. The venting system according to any one of claims 2 to 9, comprising a conduit directly connecting the fuel tank with the engine, wherein:
the direct venting valve is electrically actuated and configured for being installed in the conduit to thereby enable selectively opening or closing fluid communication between the fuel tank and the engine; and
the control unit is coupled to the sensors and to the direct venting valve, the control unit being configured for operating the direct venting valve to open or close said fluid communication according to second predetermined criteria related to said data.

11. The venting system according to claim 10, wherein said second predetermined criteria include at least pressure conditions in an airspace within the tank being considered desirable for venting to the engine.

12. The venting system according to claim 11, wherein said pressure conditions comprise a first pressure in the airspace being greater than a second pressure in a portion of said conduit between the direct venting valve and the engine.

13. The venting system according to claim 12, wherein said first pressure is greater than said second pressure by at least 3 kPa.

14. The venting system according to any one of claims 10 to 13, wherein said second predetermined criteria further include temperature conditions in an airspace within the tank being considered desirable for venting to the engine.

15. The venting system according to claim 14, wherein said temperature conditions include a temperature of greater than 30° C.

16. The venting system according to any one of claims 10 to 15, wherein said second predetermined criteria further include fuel vapor quantity conditions in an airspace within the tank being considered desirable for venting to the engine.

17. The venting system according to claim 16, wherein said fuel vapor quantity conditions is correlated to a predetermined fuel level within the tank.

18. The venting system according to claim 17, wherein said predetermined fuel level within the tank corresponds to a volume of fuel in the tank that is not greater than 80% of the volume of fuel when the tank is considered to be full.

19. A fuel system comprising the venting system, vapor recovery canister and fuel tank as defined in any one of claims 1 to 18.

20. An assembly of an engine and a fuel system, the fuel system being as defined in claim 19, wherein the main conduit is connected to the fuel tank and to the vapor recovery canister.

21. A vehicle comprising an assembly as defined in claim 20.

22. A method for venting a fuel system, the fuel system comprising at least a fuel tank and a vapor recovery canister, the fuel tank being connected to the vapor recovery canister via a main conduit, and further comprising an electrically actuated vent control valve installed in said main conduit to thereby enable selectively opening or closing fluid communication between the fuel tank and the vapor recovery canister, the method comprising selectively operating the electrically actuated vent control valve to:
prevent venting of the tank to the vapor recovery canister under predetermined conditions including at least a first said condition indicative of potential liquid carry over from the tank to the vapor recovery canister.

23. The method according to claim 22, further comprising the step of directly venting fuel vapors from the tank to an engine.

24. The method according to any one of claims 22 to 23, comprising determining whether a fuel level in the tank exceeds a baseline level of fuel, wherein said baseline level of fuel corresponds to a maximum liquid carry over safe level of fuel in the tank.

25. The venting system according to claim 24, wherein the vent control valve is maintained open if the fuel level is not greater than the baseline level.

26. The method according to claim 25, further comprising determining the acceleration/deceleration of the tank.

27. The method according to claim 26, further comprising maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

28. The method according to claim 26 or claim 27, comprising closing the vent control valve open if:
the acceleration/deceleration of the tank exceeds a respective baseline acceleration, or, if the rate of change of said acceleration/deceleration of the exceeds a baseline acceleration rate; and
a tank pressure is less than a maximum pressure corresponding to an over pressure limit for the tank which should not be exceeded.

29. The method according to any one of claims 22 to 28, comprising selectively operating the electrically actuated vent control valve to allow venting the tank to the vapor recovery canister responsive to a pressure in the tank being greater than a first predetermined threshold.

30. The method according to any one of claims 23 to 29, wherein the fuel tank is connected to the engine via a conduit, different from said main conduit, and wherein an electrically actuated direct venting valve installed in the conduit to thereby enable selectively opening or closing direct fluid communication between the fuel tank and the engine, the method further comprising
providing data indicative of conditions relating to the tank;
selectively operating the direct venting valve to allow venting the tank directly to the engine according to predetermined criteria related to said data.

31. The method according to claim 30, wherein said conditions include fuel air ratio conditions in an airspace within the tank, and wherein said predetermined criteria include said pressure conditions considered desirable for venting the tank directly to the engine.

32. The method according to claim 31, wherein said pressure conditions comprise a first pressure in the airspace being greater than a second pressure in a portion of said conduit between the direct venting valve and the engine.

33. The method according to claim 32, wherein said first pressure is greater than said second pressure by at least 3 kPa.

34. The method according to any one of claims 30 to 33, wherein said predetermined criteria further include temperature conditions in an airspace within the tank being considered desirable for venting to the engine.

35. The method according to claim 34, wherein said temperature conditions include a temperature of greater than 30° C.

36. The method according to any one of claims 30 to 35, wherein said predetermined criteria further include fuel vapor quantity conditions in an airspace within the tank being considered desirable for venting to the engine.

37. The method according to claim 36, wherein said fuel vapor quantity conditions is correlated to a predetermined fuel level within the tank.

38. The method according to claim 37, wherein said predetermined fuel level within the tank corresponds to a volume of fuel in the tank that is not greater than 80% of the volume of fuel when the tank is considered to be full.

39. A venting system for a fuel system of an engine, the fuel system including a fuel tank connectable directly to the engine via a conduit, the venting system comprising:
an electrically actuated direct venting valve configured for being installed in the conduit to thereby enable selectively opening or closing fluid communication between the fuel tank and the engine;
a plurality of sensors for providing data indicative of conditions relating to the tank;
a control unit coupled to the sensors and to the direct venting valve, the control unit configured for operating the direct venting valve to open or close said fluid communication according to first predetermined criteria related to said data.

40. The venting system according to claim 39, wherein said first predetermined criteria include at least pressure conditions in an airspace within the tank being considered desirable for venting to the engine.

41. The venting system according to claim 40, wherein said pressure conditions comprise a first pressure in the airspace being greater than a second pressure in a portion of said conduit between the direct venting valve and the engine.

42. The venting system according to claim 41, wherein said first pressure is greater than said second pressure by at least 3 kPa.

43. The venting system according to any one of claims 39 to 42, wherein said first predetermined criteria further include temperature conditions in an airspace within the tank being considered desirable for venting to the engine.

44. The venting system according to claim 43, wherein said temperature conditions include a temperature of greater than 30° C.

45. The venting system according to any one of claims 39 to 44, wherein said first predetermined criteria further include fuel vapor quantity conditions in an airspace within the tank being considered desirable for venting to the engine.

46. The venting system according to claim 45, wherein said fuel vapor quantity conditions is correlated to a predetermined fuel level within the tank.

47. The venting system according to claim 46, wherein said predetermined fuel level within the tank corresponds to a volume of fuel in the tank that is not greater than 80% of the volume of fuel when the tank is considered to be full.

48. The venting system according to any one of claims 39 to 47, further comprising a main conduit for connecting the tank to a vapor recovery canister, and an electrically actuated vent control valve configured for being installed in the main conduit to thereby enable selectively opening or closing fluid communication between the fuel tank and the vapor recovery canister.

49. The venting system according to claim 48, wherein the control unit is coupled to the sensors and to the electrically actuated vent control valve, the control unit being further configured for operating the electrically actuated vent control valve to open or close said fluid communication according to second predetermined criteria, wherein said second predetermined criteria include minimizing risk of liquid carry over (LCO) from the fuel tank to the vapor recovery canister.

50. The venting system according to claim 49, wherein the control unit is configured for causing the electrically actuated vent control valve to be closed concurrently with the direct venting valve being open.

51. The venting system according to any one of claims 48 to 50, wherein the control unit is configured for determining whether a fuel level in the tank, as sensed by at least one said sensor, exceeds a baseline level of fuel, wherein said baseline level of fuel corresponds to a maximum liquid carry over safe level of fuel in the tank.

52. The venting system according to claim 51, wherein the control unit is configured for maintaining the vent control valve open if the fuel level is not greater than the baseline level.

53. The venting system according to claim 52, wherein the control unit is further configured for determining the acceleration/deceleration of the tank.

54. The venting system according to claim 53, wherein the control unit is further configured for maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

55. The venting system according to claims 48 to 54, for example, the control unit is further configured for closing the vent control valve open if:
the control unit determines that the acceleration/deceleration of the tank exceeds a respective baseline acceleration, or, if the control unit determines that the rate of change of said acceleration/deceleration of the exceeds a baseline acceleration rate; and
the control unit determines that a tank pressure is less than a maximum pressure corresponding to an over pressure limit for the tank which should not be exceeded

56. A fuel system comprising the venting system and tank as defined in any one of claims 39 to 55.

57. An assembly of an engine and a fuel system, the fuel system being as defined in claim 56, wherein the conduit is connected to the fuel tank and to the engine.

58. The assembly according to claim 47, wherein the conduit connects the fuel tank to an intake of the engine.

59. A vehicle comprising an assembly as defined in claim 57 or claim 58.

60. A method for venting a fuel system of an engine, the fuel system comprising at least a fuel tank and connected to the engine via a conduit, and further comprising an electrically actuated direct venting valve installed in the conduit to thereby enable selectively opening or closing direct fluid communication between the fuel tank and the engine, the method comprising
providing data indicative of conditions relating to the tank;
selectively operating the direct venting valve to allow venting the tank directly to the engine according to first predetermined criteria related to said data.

61. The method according to claim 60, wherein said conditions include fuel air ratio conditions in an airspace within the tank, and wherein said first predetermined criteria include said pressure conditions considered desirable for venting the tank directly to the engine.

62. The method according to claim 61, wherein said pressure conditions comprise a first pressure in the airspace being greater than a second pressure in a portion of said conduit between the direct venting valve and the engine.

63. The method according to claim 62, wherein said first pressure is greater than said second pressure by at least 3 kPa.

64. The method according to any one of claims 60 to 63, wherein said first predetermined criteria further include temperature conditions in an airspace within the tank being considered desirable for venting to the engine.

65. The method according to claim 64, wherein said temperature conditions include a temperature of greater than 30° C.

66. The method according to any one of claims 60 to 65, wherein said first predetermined criteria further include fuel vapor quantity conditions in an airspace within the tank being considered desirable for venting to the engine.

67. The method according to claim 66, wherein said fuel vapor quantity conditions is correlated to a predetermined fuel level within the tank.

68. The method according to claim 67, wherein said predetermined fuel level within the tank corresponds to a volume of fuel in the tank that is not greater than 80% of the volume of fuel when the tank is considered to be full.

69. The method according to any one of claims 60 to 68, the fuel system comprising at least the fuel tank and a vapor recovery canister, the fuel tank being connected to the vapor recovery canister via a main conduit, and further comprising an electrically actuated vent control valve installed in said main conduit to thereby enable selectively opening or closing fluid communication between the fuel tank and the vapor recovery canister, the method further comprising selectively operating the electrically actuated vent control valve to prevent venting of the tank to the vapor recovery canister under predetermined conditions including at least a first said condition indicative of potential liquid carry over from the tank to the vapor recovery canister.

70. The method according to claim 69, further comprising selectively operating the electrically actuated vent control valve to allow venting the tank to the vapor recovery canister responsive to a pressure in the tank being greater than a first predetermined threshold.

71. The method according to claim 69 or claim 70, comprising determining whether a fuel level in the tank exceeds a baseline level of fuel, wherein said baseline level of fuel corresponds to a maximum liquid carry over safe level of fuel in the tank.

72. The method according to any one of claims 69 to 71, wherein the vent control valve is maintained open if the fuel level is not greater than the baseline level.

73. The method according to any one of claims 69 to 72, comprising determining the acceleration/deceleration of the tank.

74. The method according to claim 73, comprising maintaining the vent control valve open if:
the acceleration/deceleration of the tank does not exceed a respective baseline acceleration, and,
the control unit determines that the rate of change of said acceleration/deceleration of the tank does not exceed a baseline acceleration rate.

75. The method according to claim 73 or claim 74, comprising closing the vent control valve open if:
the acceleration/deceleration of the tank exceeds a respective baseline acceleration, or, if the rate of change of said acceleration/deceleration of the exceeds a baseline acceleration rate; and
a tank pressure is less than a maximum pressure corresponding to an over pressure limit for the tank which should not be exceeded.
